(19) United States
(12) Patent Application Publication
(10) Pub. No.: US 2023/0227657 A1
(43) Pub. Date: Jul. 20, 2023

(54) FLUORESCENT MACROMOLECULE AND USES THEREOF

(71) Applicant: QUEENSLAND UNIVERSITY OF TECHNOLOGY, BRISBANE (AU)

(72) Inventors: Christopher Winfried Barner-Kowollik, Graythorne (AU); Florian Feist, KARLSRUHE (DE); James Peter Blinco, UPPER MOUNT GRAVATT (AU); Anja Sabrina Goldmann, BALMORAL (AU)

(73) Assignee: QUEENSLAND UNIVERSITY OF TECHNOLOGY, BRISBANE (AU)

(21) Appl. No.: 17/996,191

(22) PCT Filed: Apr. 15, 2021
(86) PCT No.: PCT/AU2021/050336

§ 371 Date: Oct. 13, 2022

(30) Foreign Application Priority Data
Apr. 15, 2020 (AU) 2020901195

(51) Int. Cl. C09B 69/10; C09K 11/06; G01N 21/64

(52) U.S. Cl. CPC C09B 69/109; C09K 11/06; G01N 21/64; C09K 2211/1416; C09K 2211/1425; C09K 2211/1466; C09K 2211/1483; G01N 2021/6421

(57) ABSTRACT

A fluorescent macromolecule comprising: a linear sequence-defined backbone; and a plurality of fluorophores attached to the backbone in a pre-determined order to form a fluorophore sequence, wherein the fluorophores in the fluorophore sequence are separated from one another by a distance permitting interaction between adjacent fluorophores such that the macromolecule emits fluorescence at a plurality of wavelengths when irradiated by light to form a fluorescence emission spectrum, and wherein the fluorescence emission spectrum has a profile that is determined by the fluorophore sequence.

### TECHNICAL FIELD

The present invention relates generally to fluorescent macromolecule compositions that are capable of encoding information.

### BACKGROUND

As greater quantities of information are digitised and more digital data is generated, there arises a need for cheap and convenient ways to store and retrieve that information.

DNA sequences have been proposed for use in systems for storing digital data. In a DNA-based system, information can be stored in a DNA molecule by assigning unique integers or numbers to individual nucleotides in the DNA molecule. The individual nucleotides can then be assembled in a defined sequence to encode and store a piece of information. The arrangement of nucleotides in the sequence of the DNA molecule can be deciphered using sequencing techniques, which enables the information stored in the DNA molecule to be decoded and read.

However, one problem with using DNA molecules for data storage is that there can be issues with DNA instability, which can limit its use for long-term data storage at ambient conditions.

There have been attempts to address some of the shortcomings associated with DNA through the use of fully synthetic macromolecules. For instance, synthetic sequence-defined polymers having a composition composed of a precise and controlled series of monomers in a chain have been investigated for use in data storage. However, in order to read information stored in a synthetic polymer, the chemical composition of the polymer must be discerned. Primarily, analytic techniques such as nuclear magnetic resonance (NMR) spectroscopy and mass spectrometry have been used to ascertain and characterise the chemical composition of the polymer molecule. But an issue with those analytic techniques is that extensive data processing and analysis needs to be performed in order to determine the comonomer sequence in the polymer and thereby decipher the encoded information. That processing and analysis requires considerable effort, which can be costly and time consuming and is not generally convenient to the end user.

There remains a need to provide a synthetic macromolecule that can be utilised for digital data storage, and which can enable the stored data to be conveniently read and retrieved.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY

The present invention provides a fluorescent macromolecule comprising:
a linear sequence-defined backbone; and
a plurality of fluorophores attached to the backbone in a pre-determined order to form a fluorophore sequence,
wherein the pre-determined order of fluorophores in the fluorophore sequence is such that the fluorophores are capable of interacting to enable the macromolecule to emit fluorescence at a plurality of wavelengths when irradiated by light to form a fluorescence emission spectrum, and
wherein the fluorescence emission spectrum has a profile that is determined by the fluorophore sequence.

The pre-determined order of fluorophores in the fluorophore sequence will typically be where the fluorophores are separated from one another by a distance permitting interaction between adjacent fluorophores such that the macromolecule emits fluorescence at a plurality of wavelengths when irradiated by light to form a fluorescence emission spectrum.

The present invention may therefore also be described as providing fluorescent macromolecule comprising:
a linear sequence-defined backbone; and
a plurality of fluorophores attached to the backbone in a pre-determined order to form a fluorophore sequence,
wherein the fluorophores in the fluorophore sequence are separated from one another by a distance permitting interaction between adjacent fluorophores such that the macromolecule emits fluorescence at a plurality of wavelengths when irradiated by light to form a fluorescence emission spectrum, and
wherein the fluorescence emission spectrum has a profile that is determined by the fluorophore sequence.

The present invention also provides a method for encoding and retrieving information comprising the steps of:
providing a fluorescent macromolecule according to the invention, the macromolecule having predetermined sequence of fluorophores attached thereto to encode information;
irradiating the fluorescent macromolecule with light to obtain a fluorescence emission spectrum; and
analysing the fluorescence emission spectrum to determine the sequence of fluorophores and retrieve the encoded information.

The present invention further provides a method for determining the authenticity of an article, the method comprising the steps of:
providing an article comprising a fluorescent macromolecule according to the invention, the macromolecule having predetermined sequence of fluorophores attached thereto to encode information;
irradiating the article with light to obtain a fluorescence emission spectrum;
analysing the fluorescence emission spectrum to determine the sequence of fluorophores and retrieve the encoded information; and
comparing the retrieved information to an authentication code to authenticate the article

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

### BRIEF DESCRIPTION OF THE FIGURES

Embodiments of the invention will now be described with reference to the following nonlimiting drawings in which:

FIG. 1 is a scheme illustrating (a) a simplified and (b) detailed scheme showing the synthesis of a sequence-defined backbone from heterobifunctional monomers having maleimido (Mal) and o-methylbenzaldehyde (o-MBA) functional groups under via a photoinduced Diels-Alder reaction, involving protection and deprotection reactions of the functional groups.

FIG. 2 is a scheme illustrating a general iterative exponential growth (IEG) strategy for rapid synthesis of a linear, sequence-defined backbone of a fluorescent macromolecule of the invention.

FIG. 3 is a scheme illustrating a general iterative exponential growth (IEG) strategy for synthesis of tetramers having a fluorophore sequence of “1000” and “1010”.

FIG. 4 is a scheme illustrating a general iterative exponential growth (IEG) strategy for synthesis of a tetramer having a fluorophore sequence of “1100”.

FIG. 5 is a graph illustrating the principle of monomer and excimer fluorescence to distinguish between fluorophore sequences “1000”, “1010” and “1100”.

FIG. 6 is a scheme illustrating a procedure for reading information by analysis of the fluorescence emission spectrum of a fluorescent macromolecule of the invention.

FIG. 7 depicts the SEC-traces of monomers M₀, M₁, M₂, dimers 01, 10, 11, 22, 12 and tetramers 1001, 1010, 2121, 2211.

FIG. 8 depicts fluorescence excitation and emission spectra of sequences 2121 and 2211 in solution and in a polymer matrix.

### DETAILED DESCRIPTION

As used herein, the singular forms “a,” “an,” and “the” designate both the singular and the plural, unless expressly stated to designate the singular only.

The term “about” and the use of ranges in general, whether or not qualified by the term about, means that the number comprehended is not limited to the exact number set forth herein, and is intended to refer to ranges substantially within the quoted range while not departing from the scope of the invention. As used herein, “about” will be understood by persons of ordinary skill in the art and will vary to some extent on the context in which it is used. If there are uses of the term which are not clear to persons of ordinary skill in the art given the context in which it is used, “about” will mean up to plus or minus 10% of the particular term.

The term “C₁₋ₙalkyl” as used herein means straight or branched chain, saturated alkyl groups containing from one to n carbon atoms (e.g. n=22) and includes (depending on the identity of n) methyl, ethyl, propyl, isopropyl, n-butyl, s-butyl, isobutyl, t-butyl, 2,2-dimethylbutyl, n-pentyl, 2-methylpentyl, 3-methylpentyl, 4-methylpentyl, n-hexyl and the like, where the variable n is an integer representing the largest number of carbon atoms in the alkyl chain.

The term “C₂₋ₙalkenyl” as used herein means straight or branched chain, unsaturated alkyl groups containing from two to n carbon atoms (e.g. n=22) and at least one double bond, and includes (depending on the identity of n) vinyl, allyl, 2-methylprop-1-enyl, but-1-enyl, but-2-enyl, but-3-enyl, 2-methylbut-1-enyl, 2-methylpent-1-enyl, 4-methylpent-1-enyl, 4-methylpent-2-enyl, 2-methylpent-2-enyl, 4-methylpenta-1,3-dienyl, hexen-1-yl and the like, where the variable n is an integer representing the largest number of carbon atoms in the alkenyl chain.

The term “C₂₋ₙalkynyl” as used herein means straight or branched chain, unsaturated alkyl groups containing from two to n carbon atoms (e.g. n=22) and at least one triple bond, and includes (depending on the identity of n) ethynyl, propynyl, 2-methylprop-1-ynyl, but-1-ynyl, but-2-ynyl, but-3-ynyl, 3-methylbut-1-ynyl, 2-methylpent-1-ynyl, 4-methylpent-1-ynyl, 4-methylpent-2-ynyl, 4-methylpent-2-ynyl, penta-1,3-diynyl, hexyn-1-yl and the like, where the variable n is an integer representing the largest number of carbon atoms in the alkynyl chain.

The term “cycloalkyl” as used herein refers to an aliphatic ring system having 3 to “n” carbon atoms including (depending on the identity of n), but not limited to, cyclopropyl, cyclopentyl, cyclohexyl, and the like, where the variable n is an integer representing the largest number of carbon atoms in the cycloalkyl chain.

The term “aryl” as used herein means a monocyclic or polycyclic substituted or unsubstituted conjugated aromatic ring system. Preferred aryl may contain from 6 to n carbon atoms in the aromatic ring system. Polycyclic aryl can two or more rings in the aromatic ring system. Examples of aryl include, depending on the identity of n, phenyl, naphthyl, anthracenyl, 1,2-dihydronaphthyl, tetrahydronaphthyl, fluorenyl, and the like, where the variable n is an integer representing the largest number of carbon atoms in the aryl moiety. Non-conjugated or unsaturated rings may be fused to the conjugated ring system.

The term “heterocycloalkyl” as used herein refers to a non-aromatic monocyclic or polycyclic ring system having 3 to “n” carbon atoms and at least one heteroatom, preferably 1 to 4 heteroatoms selected from nitrogen, oxygen, and sulfur. Examples of heterocycloalkyl includes but is not limited to: aziridinyl, pyrrolidinyl, pyrrolidino, piperidinyl, piperidino, piperazinyl, piperazino, morpholinyl, morpholino, thiomorpholinyl, thiomorpholino, tetrahydrofuranyl, tetrahydrothiofuranyl, tetrahydropyranyl, pyranyl, and the like, where the variable n is an integer representing the largest number of ring atoms in the heterocycloalkyl moiety. A heterocycloalkyl group can be unsubstituted or substituted with suitable substituents.

The term “heteroaryl” as used herein means a monocyclic or polycyclic ring system containing from 5 to 14 atoms of which one or more, for example 1-8, suitably, 1-6, more suitably 1-5, and more suitably 1-4, of the atoms is a heteroatom selected from nitrogen, oxygen, and sulfur. Examples of heteroaryl groups, include, but are not limited to thienyl, imidazolyl, pyridyl, oxazolyl, indolyl, furanyl, benzothienyl, benzofuranyl and the like.

The term “halo” as used herein means halogen and includes chlorine, bromine, iodine and fluorine.

The term “optional” or “optionally” means that the subsequently described event of circumstances may or may not occur, and that the description includes instances where said event or circumstance occurs and instances in which it does not. For example, “optionally substituted aryl” means that the aryl radical may or may not be substituted and that the description includes both substituted aryl radicals and aryl radicals having no substitution.

The term “substituted” as used herein refers to a group in which one or more hydrogen atoms are each independently replaced with the same or different substituent(s). “Substituted” groups particularly refer to groups having 1 or more substituents, for instance from 1 to 5 substituents, and particularly from 1 to 3 substituents. Some examples of substituents include, but are not limited to, acyl, acylamino, acyloxy, alkoxy, substituted alkoxy, alkoxycarbonyl, alkoxycarbonylamino, amino, substituted amino, aminocarbonyl, aminocarbonylamino, aminocarbonyloxy, phenyl, aryl, alkyl, alkenyl, alkynyl, aryloxy, azido, carboxyl, cyano, cycloalkyl, substituted cycloalkyl, halogen, hydroxyl, keto, nitro, thioalkoxy, substituted thioalkoxy, thioaryloxy, thioketo, thiol, alkyl-S(O)-, aryl-S(O)-, alkyl-S(O)₂- and aryl-S(O)₂.

The term “fluorophore” as used herein refers to a molecule that, when excited with light having a selected wavelength, emits light of a different wavelength. The molecule may emit light immediately or with a delay after excitation.

All percentages (%) referred to herein are percentages by weight (w/w or w/v), unless otherwise indicated.

Polymer molecular weights referred to herein are number average molecular weight (Mₙ), unless otherwise indicated.

The present invention provides a fluorescent macromolecule comprising:
a linear sequence-defined backbone; and
a plurality of fluorophores attached to the backbone in a pre-determined order to form a fluorophore sequence,
wherein the pre-determined order (or arrangement) of fluorophores in the fluorophore sequence is such that the fluorophores are capable of interacting to enable the macromolecule to emit fluorescence at a plurality of wavelengths when irradiated by light to form a fluorescence emission spectrum, and
wherein the fluorescence emission spectrum has a profile that is determined by the fluorophore sequence.

As described herein, the fluorescent macromolecule of the invention comprises a plurality of fluorophores attached to a linear, sequence-defined backbone. The fluorophores are attached at pre-selected positions along the length of the backbone, such that a fluorophore sequence having a pre-determined order of fluorophores is then formed.

The fluorescent macromolecule comprises at least two fluorophores attached to the backbone. In some embodiments, the fluorescent macromolecule may comprise at least three, at least four, at least five, at least six, or more fluorophores, which are attached to the linear backbone in a pre-determined order (which may also be described here in as “the arrangement” of fluorophores in the fluorophore sequence).

The plurality of fluorophores are attached to and spaced along the backbone of the fluorescent macromolecule at specified intervals. This enables the fluorophores in the fluorophore sequence to be spatially separated from one another by a pre-selected distance.

In accordance with the invention, the fluorophores in the fluorophore sequence are arranged such that they are capable of interacting, which enables the macromolecule to emit fluorescence at a plurality of wavelengths when irradiated by light. In other words, the fluorophores in the fluorophore sequence are separated from one another by a distance permitting interaction between adjacent fluorophores such that the macromolecule emits fluorescence at a plurality of wavelengths when irradiated by light to form a fluorescence emission spectrum.

In some embodiments, the arrangement of fluorophores in the fluorophore sequence is such that adjacent fluorophores positioned intramolecularly within the sequence are separated from one another by not more than a desired distance. That is, it can be desirable to ensure that the separation distance and the conformational degrees of freedom between adjacent fluorophores in the fluorophore sequence permits interactions between the fluorophores to occur. If a fluorophore in the fluorophore sequence is unable to interact with a fluorophore adjacent to it (e.g. because the separation distance is too large or the conformation necessary for the interaction is energetically too unfavourable), the desired fluorescence emission may not be achieved.

The maximum distance by which adjacent fluorophores can be separated from one another can vary according to the type of fluorophore present in the macromolecule. As an example, when the fluorophore is pyrene, adjacent fluorophores in the fluorophore sequence are separated from one another by a distance of not more than 3.2 Angstroms (Å).

The fluorescent macromolecule emits fluorescence at a plurality of wavelengths when it is irradiated by light. The emitted fluorescence and its intensity at various wavelengths can be detected, thereby enabling a fluorescence emission spectrum to be formed.

Fluorophores located at different positions along the linear backbone of the macromolecule can be excited by different wavelengths of light and can emit fluorescence of different intensities upon excitation. A fluorescence emission spectrum generated by the fluorescent macromolecule of the invention may have a particular profile or shape, which reflects the sequence in which the fluorophores are arranged along the linear backbone. Subsequent analysis and characterisation of the fluorescence spectrum profile can enable the fluorophore sequence to be read. Thus, optical means can be used to detect and obtain information that may be encoded by the fluorophore sequence.

In one embodiment, the plurality of fluorophores is evenly spaced apart along the linear backbone, such that a fluorophore sequence having a substantially uniform distribution of fluorophores is obtained.

In another embodiment, the plurality of fluorophores is spaced apart by two or more different distances, such that a fluorophore sequence comprising a non-uniform distribution of fluorophores is obtained.

In a further embodiment, there is a fluorophore pair that forms part of the fluorophore sequence. The fluorophore pair is composed of two fluorophores that are proximal to one another.

By fluorophores being “proximal” is meant that the spacing between the fluorophores is such that the fluorophores are sufficiently close to allow one fluorophore to interact, overlap or otherwise associate with another fluorophore.

Thus fluorophores in a fluorophore pair are close enough to permit electronic interactions that alterate emissive behaviour. Interaction between the fluorophores in the fluorophore pair may produce excimer, exciplex or H-dimer fluorescence. Excimer, exciplex or H-dimer fluorescence can differ from fluorescence emitted by a single fluorophore in intensity and/or emission profile.

The fluorophores attached to the linear, sequence-defined backbone may be arranged such that a fluorophore sequence having a combination of one or more single fluorophores and one or more fluorophore pairs is formed. The single fluorophore(s) and fluorophore pair(s) can be arranged in any desirable order along the linear backbone.

A single fluorophore and a fluorophore pair in a fluorophore sequence may each exhibit a fluorescence maximum, which may be characterised as the wavelength at which peak fluorescence output occurs.

In one embodiment, a fluorophore pair and a single fluorophore within a fluorophore sequence can exhibit fluorescence maxima at different wavelengths. In a particular embodiment, the fluorescence maxima exhibited by a fluorophore pair may occur at a longer wavelength than that exhibited by a single fluorophore.

In one embodiment, the plurality of fluorophores present in the fluorescent macromolecule of the invention may each be of the same type. If the fluorescent macromolecule comprises a single type of fluorophore, a fluorophore attached at one position along the linear backbone may emit fluorescence at different a wavelength and/or of different intensity, compared to a fluorophore attached at another position along the backbone. This could arise due to differences in the electronic environment in the local vicinity of the fluorophore.

In another embodiment, the fluorescent macromolecule may comprise fluorophores of two or more different types. The presence of at least two different types of fluorophores may be advantageous in some embodiments as greater variety could be engineered in the fluorophore sequence, thereby enabling fluorescence emission spectra of greater complexity and different spectral profiles to be achieved.

A range of different fluorophores may suitably be used in the fluorescent macromolecule of the invention. For instance, fluorophores useful for the present invention may belong to a class selected from polycyclic aromatic hydrocarbons, polycyclic aromatic imides, polycyclic aromatic diimides, diaryl alkenes and diaryl alkynes.

In one embodiment, fluorophores useful for the present invention may be polycyclic moieties comprising at least one aryl group. The aryl group may be fused with at least one group selected from an aryl group, a heteroaryl group, a cycloalkyl group and a heterocycloalkyl group.

In one embodiment, the fluorophore may be an optionally substituted bicyclic aryl, optionally substituted polycyclic aryl or optionally substituted arylheterocyclyl. Optional substituents can be selected from halo, linear or branched C₁₋₂₂ alkyl, linear or branched C₂₋₂₀ alkenyl, linear or branched C₂₋₂₀ alkynyl, C₃₋₂₀ cycloalkyl, C₆₋₁₄ aryl, C₅₋₁₄ heteroaryl, N(R¹)₂, OR¹, SR¹, S(O)R¹, S(O₂R¹), C(O)R¹, C(O₂)R¹, C(O)NHR¹ and C(O)N(R¹)₂, where R¹ is selected from a hydrogen atom and a saturated or unsaturated C₁ to C₂₂ aliphatic group optionally comprising one or more heteroatoms selected from N, O and S, an aryl group, and a heteroaryl group with thio-ether, amino, alkoxy or alkyl groups with 1 to 22 carbon atoms. Optionally, a substituent group may be fused with the fluorophore.

In one embodiment, the fluorophore is optionally substituted C₁₀₋₄₀-aryl or optionally substituted C₉₋₄₀-heteroaryl, wherein the optional substituents are selected from halo, C₁₋₂₀-alkyl, C₂₋₂₀-alkenyl, C₂₋₂₀-alkynyl, C₃₋₂₀ cycloalkyl, C₆₋₁₄-aryl, and C₅₋₁₄-heteroaryl.

In another embodiment, the fluorophore is optionally substituted C₁₀₋₂₀-aryl or optionally substituted C₉₋₂₀-heteroaryl, wherein the optional substituents are selected from halo, C₁₋₂₀-alkyl, C₂₋₂₀-alkenyl, C₂₋₂₀-alkynyl, C₃₋₂₀ cycloalkyl, C₆₋₁₄-aryl, and C₅₋₁₄-heteroaryl.

In one embodiment, the fluorescent macromolecule comprises at least one optionally substituted fluorophore having a structure as shown below:

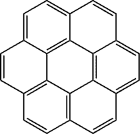 [SMILES: c1cc2ccc3ccc4ccc5ccc6ccc1c1c2c3c4c5c61]

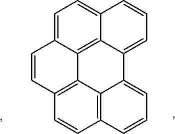

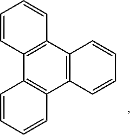

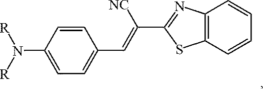

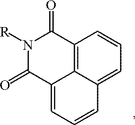

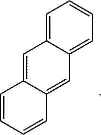

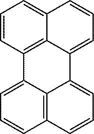 [SMILES: c1cc2cccc3c4cccc5cccc(c(c1)c23)c54]

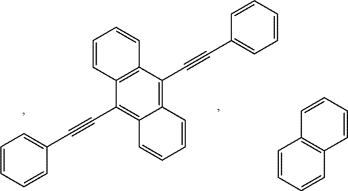

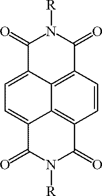

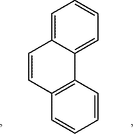

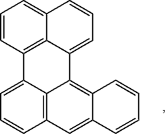

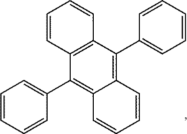

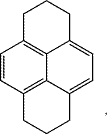

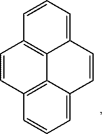

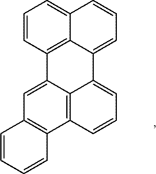

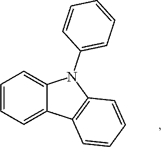

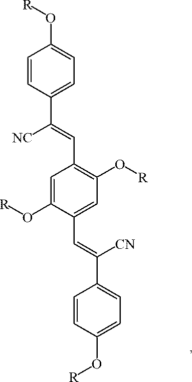

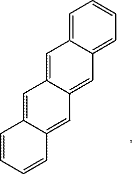

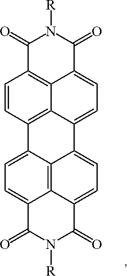

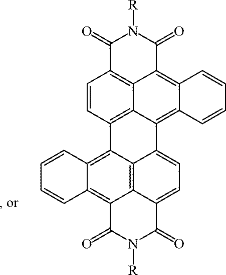

wherein the optional substituent is selected from halo, carboxy, hydroxyl, C₁₋₂₀-alkyl, C₂₋₂₀-alkenyl, C₂₋₂₀-alkynyl, C₃₋₂₀-cycloalkyl, C₁₋₂₀-alkoxy, -NR′R″ C₆₋₁₄-aryl, and C₅₋₁₄-heteroaryl, where R′ and R″ are simultaneously or independently H or C₁₋₂₂alkyl, and wherein R is selected from optionally substituted C₁₋₂₂ alkyl, optionally substituted C₂₋₂₀ alkenyl, optionally substituted C₂₋₂₀ alkynyl, optionally substituted C₃₋₂₀ cycloalkyl, optionally substituted C₆₋₁₄ aryl, and optionally substituted C₅₋₁₄ heteroaryl optionally.

The optionally substituted fluorophore can be attached to the linear, sequence-defined backbone of the fluorescent macromolecule via any suitable position on the fluorophore molecule. A point of attachment on the optionally substituted fluorophore to the linear, sequence-defined backbone is therefore not depicted in the structures directly above.

In one embodiment, fluorophores useful for the present invention are excimer forming fluorophores. Excimer forming fluorophores are those that are capable of interacting to generate excimer fluorescence. Excimer fluorescence may be detected as an increase in fluorescence intensity at longer wavelengths.

In an exemplary embodiment, the fluorescent macromolecule of the invention comprises an optionally substituted fluorophore of formula (XV):

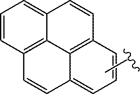

A skilled person would appreciate that the fluorophore of formula (XV) is a pyrenyl fluorophore. Pyreneyl fluorophores are capable of emitting excimer fluorescence. The skilled person would also appreciate the feature

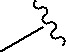

in structure (XV) is short hand way of indicating that fluorophore can be attached to the linear, sequence-defined backbone of the fluorescent macromolecule via any suitable position on the fluorophore molecule.

In one embodiment, the fluorescent macromolecule of the invention comprises a plurality of optionally substituted fluorophores of formula (XV).

As described herein, the plurality of fluorophores are attached to a linear, sequence-defined backbone. The term “sequence-defined” as used herein with reference to the backbone of the fluorescent macromolecule indicates that the backbone has a defined chemical composition and is composed of a precisely defined arrangement of monomeric backbone units. The formation of a sequence-defined backbone can be achieved through the use of appropriately functionalised monomers and by controlling the backbone synthesis process, such that construction of the backbone and its subsequent composition is highly controlled.

It is preferred that the linear backbone is of a defined length and molecular weight (i.e. it is monodisperse). That can be achieved by controlling the composition of the backbone and its fabrication.

The linear, sequence-defined backbone of the fluorescent macromolecule is composed of a plurality of backbone units, which are linked together to form the backbone. As discussed below, the backbone units are generally derived from monomers used to prepare the backbone.

Two or more of the backbone units have a fluorophore attached thereto. It would be appreciated that it is not necessary for each backbone unit to have a fluorophore attached, provided that there is a fluorophore attached to at least two of the backbone units of the linear backbone.

The linear backbone of the fluorescent macromolecule is preferably a rigid structure. By being “rigid”, the backbone has limited flexibility and is restricted in its ability to undergo conformational changes, such as rotation, bending or folding. Accordingly, the backbone can be of a substantially straight, linear form.

The linear, sequence-defined backbone can be formed by reacting selected monomers together under controlled conditions. Upon reaction, the monomers become incorporated in the chemical structure of the backbone as monomeric units. The monomeric units are also be regarded herein as backbone units of the linear backbone.

The linear backbone may be an oligomeric moiety (i.e. a moiety composed of from 2 to 4 monomeric or backbone units) or a polymeric moiety (i.e. a moiety composed of 5 or more monomeric or backbone units).

In one embodiment, there can be as little as 2 backbone units or as many as over 100 backbone units in the linear backbone of the fluorescent macromolecule. The number of backbone units influence the size (i.e. molecular weight or length) of the linear backbone.

In some embodiments, the linear, sequence-defined backbone comprises from 2 backbone units, and up to 90, 80, 70, 60, 50, 40, 30, 25, 20, 15 and 10 backbone units. The linear backbone may comprise any number of backbone units within these ranges.

The backbone units in the linear backbone can be linked to one another via suitable means. In one set of embodiments, the backbone units are linked via a cyclohexyl moiety. That is, a backbone unit is linked to a backbone unit adjacent to it via a cyclohexyl moiety. The use of a cyclohexyl moiety to couple the backbone units to one another may help to impart rigidity to the backbone.

The cyclohexyl moiety that links backbone units together can be a product formed from an addition reaction between appropriately functionalised monomers. In one embodiment, the cyclohexyl moiety is the product of a Diels-Alder reaction. A skilled person would understand that a Diels-Alder reaction is an organic chemical reaction (specifically, a [4+2] cycloaddition) between a conjugated diene and an alkene (i.e. a dienophile). The diene and dienophile react under appropriate reaction conditions to form a cyclohexyl moiety.

In one preference, the linear backbone is derived from an orthogonally reactive heterobifunctional monomer (i.e. an AB-type monomer). The heterobifunctional monomer will generally have two different functional groups that are complementary to one another and which can covalently react under orthogonal conditions in order to intermolecularly link different monomers together. The heterobifunctional monomer may also comprise additional functional groups that do not react (i.e. polymerise) to form the backbone chain.

Preferably, a heterobifunctional monomer contains two different functional groups of complementary functionality. Thus a first functional group on a heterobifunctional monomer can react with a complementary second functional group on another heterobifunctional monomer, in order to covalently link the two monomers together. Following reaction of the two monomers, a dimer is then formed.

In one embodiment, heterobifunctional monomers useful for the formation of the linear sequence-defined backbone comprise functional groups that are capable of participating in a Diels-Alder reaction to form a cyclohexyl moiety that links different monomeric units together in the backbone.

For instance, the heterobifunctional monomer can comprise a first functional group which provides a diene, and a second functional group which provides a dienophile for a Diels-Alder reaction. A number of different functional groups may be capable of providing a diene and a dienophile and a skilled person would be able to select suitable functional groups for that purpose.

Suitable dienophiles include unsaturated electron-poor compounds, for instance vinylesters, vinylamides, maleamic esters, fumerates and alkynoates. Dienes may be generated from 2-hydroxymethyl phenols, 2-alkoxymethyl phenols, 8,13-Dihydrobenzo[g]naphtho[1,8-bc][ 1,5]diselenonines or o-formyl anilides.

A benefit of the use of a heterobifunctional monomer having functional groups that are capable participating in a Diels-Alder reaction is that coupling of the monomers and formation of the linear backbone may proceed with high efficiency and selectively, allowing a high level of control over the size and composition of the linear backbone.

In one embodiment, heterobifunctional monomers can be coupled to a growing chain one by one, thereby allowing the linear backbone to be grown in a stepwise, iterative manner.

In one embodiment, the backbone units are derived from a heterobifunctional monomer comprising a ortho-methyl benzaldehyde functional group and a maleimido functional group. The benzaldehyde functional group may be capable of providing a diene for a Diels-Alder reaction, while the maleimido functional group is capable of providing a dienophile. In a particular embodiment, the heterobifunctional monomer comprises a maleimido functional group and a 2-methyl-6-alkyloxy-benzaldehyde (o-MBA) functional group.

In one exemplary embodiment, when the heterobifunctional monomer comprises a maleimido functional group and a ortho-methyl benzaldehyde functional group, the two different functional groups can be linked to one another within the monomer via a linking group of desired structure. Examples of linking groups are described below.

The ortho-methyl benzaldehyde functional group may be photoreactive and can react with the maleimido functional group when irradiated by light. The covalent reaction of an ortho-methyl benzaldehyde functional group with a maleimido functional group present in different monomers can occur under conditions suitable for photoinduced [4+2] cycloaddition to generate a cyclohexyl moiety that links the monomers together. The linked monomers therefore form backbone units, which are part of the linear, sequence-defined backbone of the fluorescent macromolecule.

Advantageously, when the heterobifunctional monomer comprises an ortho-methyl benzaldehyde functional group, the ortho-methyl benzaldehyde functional group can be converted into an ortho-quinodimethane functional group when it is irradiated by UV light. The formed o-quinodimethane functional group acts as a reactive diene and can react with a maleimido functional group (acting as a dienophile) under photo-induced Diels-Alder conditions to form a cyclohexyl moiety that links two heterobifunctional monomers together.

Suitable conditions may be employed to promote the photochemically induced Diels-Alder reaction between an ortho-methyl benzaldehyde functional group and a maleimido functional group on different monomers. In one set of embodiments, the conditions involve the irradiation of two or more heterobifunctional monomers with light, preferably visible or UV light, to induce the Diels-Alder reaction. Some examples of photo-ligation conditions that may be used to couple a Benzaldehyde functional group with a maleimido functional group to form a Diels-Alder adduct are described in J. Am. Chem. Soc., 2018, 140, 11848-11854. In one preference, the monomers can be irradiated by light having a wavelength in the range of from 300 to 450 nm for a time period of from about 5 minutes to 60 minutes, preferably about 10 to 50 minutes.

In some embodiments, the maleimido functional group and the ortho-methyl benzaldehyde functional group in a heterobifunctional monomer may each be protected by a suitable a protecting group that renders the functional group unreactive until it is deprotected.

In one embodiment, the maleimido functional group may be protected with a furan group, while the ortho-methyl benzaldehyde functional group may be protected with an imine group, O,O-acetal, O,S-acetal or S,S-acetal. Other suitable protecting groups may be used. The protecting groups may be selectively removed via a deprotection step to reveal the reactive functionality. As an example, an dimethylacetal group protecting the benzaldehyde functional group of a o-methyl benzaldehyde group can be removed by acid-mediated cleavage to yield a reactive o-methyl benzaldehyde (o-MBA) group, while deprotection of the furan-protected maleimido functional group can be achieved via a retro-Diels-Alder reaction, to reveal a reactive maleimido group. The complementary and deprotected maleimido and benzaldehyde functional groups may then covalently react under a photo-induced Diels-Alder reaction.

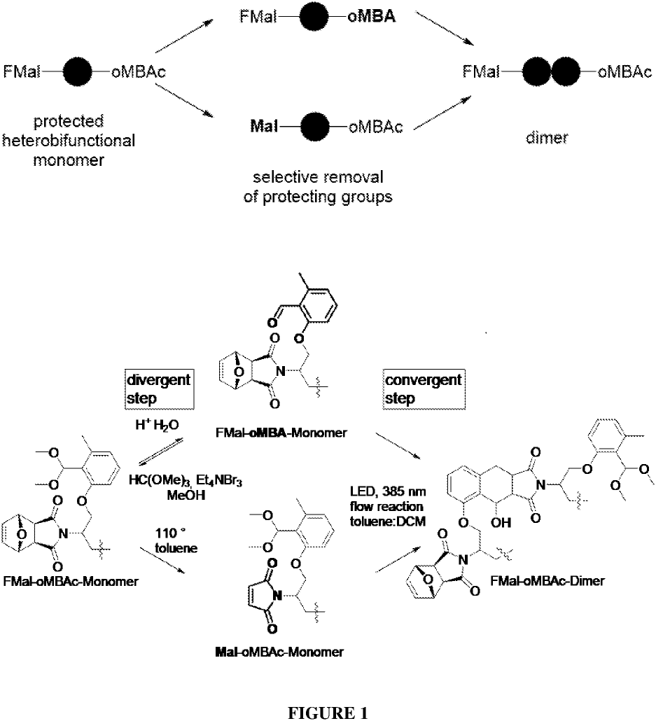

Two heterobifunctional monomers with complementary functional groups can be linked together to form a dimer. The dimer may have the same terminal functional groups (either in protected or deprotected form) as that of the heterobifunctional monomer. The dimer may undergo the same deprotection and/or covalent reaction steps to enable at least one further heterobifunctional monomer to be coupled to the dimer, thereby enabling the linear backbone chain to be extended in modular fashion. A scheme illustrating deprotection and covalent coupling of a heterobifunctional monomer to form a dimer is shown in FIG. 1.

In some embodiments, more than one monomer can be coupled with a growing linear backbone at the same time. For example, there may be an initial symmetrically functionalised molecule active as a starting core. Chain extension and formation of the linear, sequence-defined backbone can then occur via the simultaneous coupling of monomers at both ends of the core.

In some embodiments, instead of step-wise growth of the linear backbone chain, it may be possible to initially assemble oligomers composed of a few backbone units, which are derived from the heterobifunctional monomer. In one form, the oligomers may be molecules composed of from 2 to 4 backbone units.

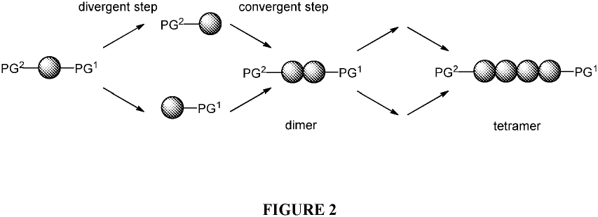

The pre-formed oligomers can contain a first functional group providing a diene, and a second functional group providing a dienophile, which are capable of reacting in a Diels-Alder reaction under suitable conditions. The pre-formed oligomers may thus be coupled together through a Diels-Alder reaction, thereby allowing an iterative exponential growth (IEG) strategy to be used for rapid growth of the linear backbone. For example, the coupling of two dimers via covalent reaction of complementary functional groups on different dimers can result in the formation of a tetramer, while the coupling of two tetramers can result in the formation of an octamer, and so on. Oligomers of different size may be coupled together. For example, a dimer may be coupled with a tetramer to provide a hexamer. A scheme illustrating the synthesis of a tetramer from pre-formed dimers is shown in FIG. 2.

The linear, sequence-defined backbone described herein comprises a plurality of backbone units. It is desirable that two or more of the backbone units that form the linear, sequence-defined backbone have a fluorophore attached thereto. A backbone unit having a fluorophore attached thereto is also described herein as a fluorophore backbone unit.

The fluorophore is preferably attached to a backbone unit of the linear, sequence-defined backbone via a linker group. The linker group is preferably of a size and structure that facilitates interactions between adjacent fluorophores that are spaced apart by a desirable distance along the linear backbone. The size of the linker group can be adjusted to suit a selected fluorophore.

The linker group may be straight-chained, branched, cyclic, or aryl, or a combination of all three, and connects a fluorophore with the linear, sequence-defined backbone. The linker group may optionally contain a heteroatom, such as nitrogen, oxygen or sulfur heteroatom, or a divalent functional group, such as an amide, ester, ether or carbonyl functional group.

In some embodiments, the linker group attaching the fluorophore to the linear, sequence-defined backbone may be selected to enhance the solubility of the fluorescent macromolecule in a desired solvent. For example, a linker group derived from an α-, β-, γ-or δ- amino acid, or from a poly(ethylene glycol) of desired molecular weight, might help to improve the solubility of the macromolecule in various solvents.

Fluorophore backbone units in the linear, sequence-defined backbone may have a structure selected from those of formula (I), (II) or (III), as described herein below.

In one embodiment, the linear, sequence-defined backbone of the fluorescent macromolecule comprises a fluorophore backbone unit of formula (I):

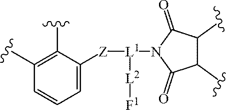

wherein:

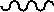

represents linkage to a cyclohexyl moiety coupling the backbone unit to an adjacent backbone unit;
Z is selected from O, N and S (preferably O or S);
L¹ is a first linker group that may be absent or present and when present, is selected from an optionally substituted linear or branched C₁ to C₄ saturated or unsaturated aliphatic group optionally comprising one or more heteroatoms selected from O, N and S;
L² is a second linker group selected from an optionally substituted saturated or unsaturated C₁ to C₁₆ aliphatic group, an optionally substituted aryl group, and an optionally substituted heteroaryl group, wherein said aliphatic, aryl or heteroaryl group optionally comprises at least one selected from a heteroatom selected from O, N and S and a divalent functional group; and
F¹ is a fluorophore.

In the backbone unit of formula (I), there is a phenyl moiety and a succinimidyl moiety. The phenyl and succinimidyl moieties are residues formed after the reaction of a benzaldehyde functional group and a maleimido functional group in a Diels-Alder reaction, respectively.

In formula (I), L¹ is a linker group that links the phenyl and succinimidyl moieties of the backbone unit together, while L² is a linker group that couples the fluorophore moiety (F¹) to the first linker group (L¹) of the backbone unit.

The composition and size of the linker group L² described herein may be selected having regard to the fluorophore and other structural features in the backbone unit.

In one embodiment of formula (I), L² is selected from an optionally substituted saturated or unsaturated C₁ to C₁₆ aliphatic group, an optionally substituted aryl group, and an optionally substituted heteroaryl group, wherein said aliphatic, aryl or heteroaryl group optionally comprises a divalent functional group. Examples of divalent functional groups include carbonyl, amide, ester, ether, thio-ester and thio-ether functional groups.

In some embodiments, the group -(Z-L¹-L²-F¹) in formula (I) may have a structure selected from the following:

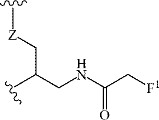

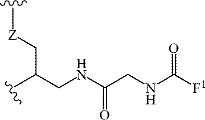

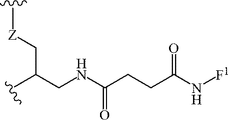

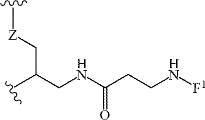

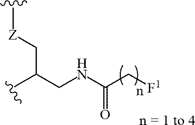

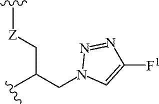

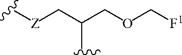

In another embodiment, the linear, sequence-defined backbone of the fluorescent macromolecule comprises a fluorophore backbone unit of formula (II):

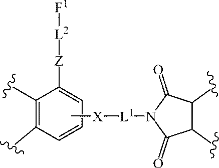

wherein:

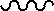

represents linkage to a cyclohexyl moiety coupling the backbone unit to an adjacent backbone unit;
Z is selected from O, N and S (preferably O or S);
X may be absent or present, and when present is a heteroatom selected from O, N and S;
L¹ is a first linker group that may be absent or present and when present, is selected from an optionally substituted linear or branched C₁ to C₄ saturated or unsaturated aliphatic group optionally comprising one or more heteroatoms selected from O, N and S;
L² is a second linker group selected from an optionally substituted saturated or unsaturated C₁ to C₁₆ aliphatic group, an optionally substituted aryl group, and an optionally substituted heteroaryl group, wherein said aliphatic, aryl or heteroaryl group optionally comprises at least one selected from a heteroatom selected from O, N and S and a divalent functional group; and
F¹ is a fluorophore.

In one embodiment of a backbone unit of formula (II), X is absent or is O.

When X is absent, then the phenyl and succinimidyl moieties of the backbone unit are linked with one another via the linker group L¹.

In one embodiment of a backbone unit of formula (II), X is absent and L¹ is absent. A skilled person would understand that when X and L¹ are each absent, then the phenyl and succinimidyl moieties of the backbone unit are directly linked with one another via a bond, preferably a single bond.

In the backbone unit of formula (II), L² is a linker group that couples the fluorophore (F¹) to the phenyl moiety of the backbone unit.

In one embodiment of formula (II), L² is selected from an optionally substituted saturated or unsaturated C₁ to C₁₆ aliphatic group, an optionally substituted aryl group, and an optionally substituted heteroaryl group, wherein said aliphatic, aryl or heteroaryl group optionally comprises a divalent functional group. Examples of divalent functional groups include carbonyl, amide, ester, ether, thio-ester and thio-ether functional groups.

In some embodiments, the group —(Z—L²—F¹) in formula (II) may have a structure selected from the following:

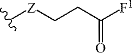

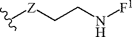

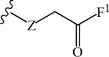

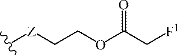

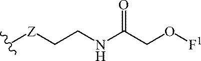

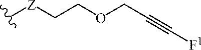

In another embodiment, the linear, sequence-defined backbone of the fluorescent macromolecule comprises a fluorophore backbone unit of formula (III):

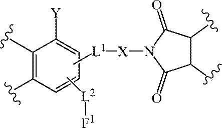

wherein:

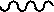

represents linkage to a cyclohexyl moiety coupling the backbone unit to an adjacent backbone unit;
Y is selected from OR², NR²R³, SR², S(O)R², and S(O₂)R²;
R² and R³ may each be independently selected from H, an optionally substituted saturated or unsaturated C₁-C₂₂ aliphatic group comprising one or more heteroatoms selected from O, N and S, an optionally substituted C₆ to C₁₂ cycloalkyl or fused polycycloalkyl, an optionally substituted aryl, and and optionally substituted heteroaryl;
X may be absent or present, and when present is a heteroatom selected from O, N and S;
L¹ is a first linker group that may be absent or present and when present, is selected from an optionally substituted linear or branched C₁ to C₄ saturated or unsaturated aliphatic group optionally comprising one or more heteroatoms selected from O, N and S;
L² is a second linker group selected from an optionally substituted saturated or unsaturated C₁ to C₁₆ aliphatic group, an optionally substituted aryl group, and an optionally substituted heteroaryl group, wherein said aliphatic, aryl or heteroaryl group optionally comprises at least one selected from a heteroatom selected from O, N and S and a divalent functional group; or
L² is a heterocycloalkyl group fused with the phenyl ring and F¹; and
F¹ is a fluorophore.

In one embodiment of a backbone unit of formula (III), X is absent.

In one embodiment of a backbone unit of formula (III), L¹ is an optionally substituted C₁-C₃ saturated or unsaturated aliphatic group.

In one embodiment of a backbone unit of formula (III), L² is a C₁ to C₁₆ aliphatic group optionally comprising one or more heteroatoms selected from O, N and S, a divalent functional group (such as an amide group), and a heterocycloalkyl group fused with the phenyl ring and F¹.

In one embodiment of formula (III), L² is selected from an optionally substituted saturated or unsaturated C₁ to C₁₆ aliphatic group, an optionally substituted aryl group, and an optionally substituted heteroaryl group, wherein said aliphatic, aryl or heteroaryl group optionally comprising a divalent functional group selected from a carbonyl, amide, ester, ether, thio-ester and thio-ether functional group.

In some embodiments, the group —(L²—F¹) in formula (III) may have a structure selected from the following:

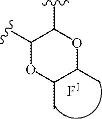

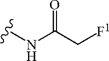

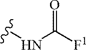

The linear, sequence-defined backbone may comprise a combination of at least two different types of fluorophore backbone units. In one embodiment, the different fluorophore backbone units may be at least two selected from formula (I), (II) and (III) defined herein.

In some embodiments of formula (I), (II) and (III), the fluorophore moiety (F¹) may be selected from any one of those described herein. In some particular embodiments of formula (I), (II) and (III), F¹ is a pyrenyl moiety.

Fluorophore backbone units forming part of the linear, sequence defined backbone may be arranged to ensure that the linear backbone comprises at least one pair of fluorophore backbone units. A pair of fluorophore backbone units is composed of two backbone units, where each of the backbone units in the pair has a fluorophore attached thereto. The fluorophore backbone units in the pair are thus adjacent to and linked to one another. The presence of at least one pair of fluorophore backbone units can help to ensure that the fluorophore sequence of the macromolecule comprises at least one fluorophore pair. In one preference, the pair of fluorophore backbone units comprises a pair of pyrene fluorophores.

An example of a pair of fluorophore backbone units comprising pyrenyl fluorophores is shown below.

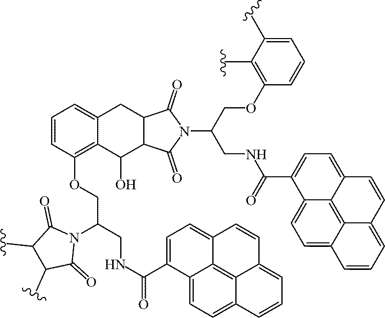

The linear, sequence-defined backbone of the fluorescent macromolecule also comprises non-fluorophore backbone units in combination with the fluorophore backbone units. Non-fluorophore backbone units are backbone units having no fluorophore attached thereto.

Non-fluorophore backbone units can be used to separate and space apart the fluorophore backbone units that are present in the linear backbone by a selected distance. The non-fluorophore backbone units are therefore used to modify the spacing in between fluorophore backbone units, to enable the distribution and order of fluorophore backbone units in the linear backbone to be controlled. In turn, this can enable a desired fluorophore sequence to be formed.

Non-fluorophore backbone units may be of similar structure to backbone units of formula (I), (II) and (III), however, the fluorophore moiety (F¹) will be absent.

In one embodiment, the linear, sequence-defined backbone of the fluorescent macromolecule comprises a non-fluorophore backbone unit of formula (Ia):

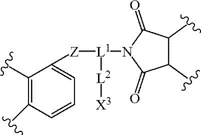

wherein:

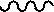

represents linkage to a cyclohexyl moiety coupling the backbone unit to an adjacent backbone unit;
Z is selected from O, N and S (preferably O or S);
L¹ is a first linker group that may be absent or present and when present, is selected from an optionally substituted linear or branched C₁ to C₄ saturated or unsaturated aliphatic group optionally comprising one or more heteroatoms selected from O, N and S;
L² is a second linker group selected from an optionally substituted saturated or unsaturated C₁ to C₁₆ aliphatic group, an optionally substituted aryl group, and an optionally substituted heteroaryl group, wherein said aliphatic, aryl or heteroaryl group optionally comprises at least one selected from a heteroatom selected from O, N and S and a divalent functional group; and
X³ is selected from H, OH, an optionally substituted saturated or unsaturated C₁ to C₁₆ aliphatic group, an optionally substituted aryl group, and an optionally substituted heteroaryl group.

In another embodiment, the linear, sequence-defined backbone of the fluorescent macromolecule comprises a non-fluorophore backbone unit of formula (IIa):

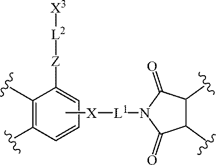

wherein:

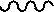

represents linkage to a cyclohexyl moiety coupling the backbone unit to an adjacent backbone unit;
Z is selected from O, N and S (preferably O or S);
X may be absent or present, and when present is a heteroatom selected from O, N and S;
L¹ is a first linker group that may be absent or present and when present, is selected from an optionally substituted linear or branched C₁ to C₄ saturated or unsaturated aliphatic group optionally comprising one or more heteroatoms selected from O, N and S;
L² is a second linker group selected from an optionally substituted saturated or unsaturated C₁ to C₁₆ aliphatic group, an optionally substituted aryl group, and an optionally substituted heteroaryl group, wherein said aliphatic, aryl or heteroaryl group optionally comprises at least one selected from a heteroatom selected from O, N and S and a divalent functional group; and
X³ is selected from H, OH, an optionally substituted saturated or unsaturated C₁ to C₁₆ aliphatic group, an optionally substituted aryl group, and an optionally substituted heteroaryl group.

In another embodiment, the linear, sequence-defined backbone of the fluorescent macromolecule comprises a non-fluorophore backbone unit of formula (IIIa):

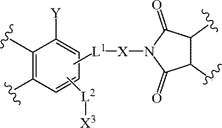

wherein:

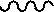

represents linkage to a cyclohexyl moiety coupling the backbone unit to an adjacent backbone unit;
Y is selected from OR², NR²R³, SR², S(O)R², and S(O₂)R²;
R² and R³ may each be independently selected from H, an optionally substituted saturated or unsaturated C₁-C₂₂ aliphatic group comprising one or more heteroatoms selected from O, N and S, an optionally substituted C₆ to C₁₂ cycloalkyl or fused polycycloalkyl, an optionally substituted aryl, and an optionally substituted heteroaryl;
X may be absent or present, and when present is a heteroatom selected from O, N and S;
L¹ is a first linker group that may be absent of present and when present, is selected from an optionally substituted linear or branched C₁ to C₄ saturated or unsaturated aliphatic group optionally comprising one or more heteroatoms selected from O, N and S;
L² is a second linker group that may be absent or present and when present is selected from an optionally substituted saturated or unsaturated C₁ to C₁₆ aliphatic group, an optionally substituted aryl group, and an optionally substituted heteroaryl group, or a heterocycloalkyl group fused with the phenyl ring and X³, wherein said aliphatic, aryl or heteroaryl group optionally comprises at least one selected from a heteroatom selected from O, N and S and a divalent functional group; and
X³ may be absent or present and when present is selected from H, OH, an optionally substituted saturated or unsaturated C₁ to C₁₆ aliphatic group, an optionally substituted aryl group, and an optionally substituted heteroaryl group.

In some embodiments, non-fluorophore backbone units present in the linear backbone may have a structure of formula (Ia), (IIa) or (IIIa) as described herein. A combination of two or more different types of non-fluorophore backbone units may be present in the backbone.

In one set of embodiments, a fluorescent macromolecule of the invention comprises a linear, sequence-defined backbone comprising at least one non-fluorophore backbone unit and a plurality of fluorophore backbone units.

The plurality of fluorophore backbone units may preferably comprise at least one pair of fluorophore backbone units.

The linear, sequence-defined backbone may comprise a plurality of non-fluorophore backbone units in combination with the plurality of fluorophore backbone units.

The fluorophore and non-fluorophore backbone units are arranged to provide a pre-determined fluorophore sequence.

As described above, backbone units of the linear sequence-defined backbone are linked to one another via a cyclohexyl moiety. The cyclohexyl moiety is therefore an intermediate moiety that is located in between adjacent backbone units and is fused with the backbone units in order to conjugate them together.

In some embodiments, cyclohexyl-linked backbone units in the linear backbone of the fluorescent macromolecule may have a structure of formula (IV):

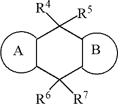

wherein:
A and B each represent a backbone unit moiety;
R⁴ is OH,
R⁵ is selected from hydrogen, optionally substituted saturated or unsaturated C₁₋₂₂ alkyl, optionally substituted saturated or unsaturated C₁₋₂₂ heteroalkyl, optionally substituted aryl, optionally substituted heteroaryl, optionally substituted amino, and optionally substituted C₁₋₂₂ alkoxy,
R⁶ and R⁷ are each independently selected from hydrogen, optionally substituted saturated or unsaturated C₁₋₂₂ alkyl, optionally substituted saturated or unsaturated C₁₋₂₂ heteroalkyl, optionally substituted aryl, optionally substituted heteroaryl, optionally substituted amino, and optionally substituted C₁₋₂₂ alkoxy, or
R⁶ and R⁷ together form a optionally substituted 4 to 8-membered cycloalkyl or heterocycloalkyl ring; or
one of R⁶ and R⁷ forms an optionally substituted 6 to 9-membered cycloalkyl or hetercycloalkyl ring fused with either A or B, while the other of R⁶ and R⁷ is H.

It would appreciated that moieties A and B each belong to different backbone units, and that the cyclohexyl moiety in formula (IV) couples the different backbone units together via moieties A and B.

In one embodiment of formula (IV), one of A and B is an optionally substituted 5-membered heterocycloalkyl moiety comprising a heteroatom selected from N, O and S, while the other of A and B is a 5-6 membered aryl moiety.

In one embodiment of formula (IV), A is a succinimidyl moiety. The succinimidyl moiety can be a residue derived from a maleimido functional group and can be formed following reaction of the maleimido functional group in a Diels-Alder reaction, to form the cyclohexyl moiety.

In one embodiment of formula (IV), B is a phenyl moiety. The phenyl moiety can be a residue derived from a benzaldehyde functional group and can be formed following reaction of the benzaldehyde functional group in a Diels-Alder reaction, to form the cyclohexyl moiety.

In a particular embodiment, cyclohexyl-linked backbone units in the linear backbone of the fluorescent macromolecule may have a structure of formula (V):

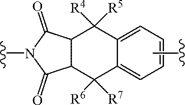

wherein:
R⁴ is OH,
R⁵ is selected hydrogen, optionally substituted saturated or unsaturated C₁-C₂₂ alkyl, optionally substituted saturated or unsaturated C₁-C₂₂ heteroalkyl, optionally substituted aryl, optionally substituted heteroaryl, optionally substituted amino, and optionally substituted C₁-C₂₂ alkoxy,
R⁶ and R⁷ are each independently selected from hydrogen, optionally substituted saturated or unsaturated C₁-C₂₂ alkyl, optionally substituted saturated or unsaturated C₁-C₂₂ heteroalkyl, optionally substituted aryl, optionally substituted heteroaryl, optionally substituted amino, and optionally substituted C₁-C₂₂ alkoxy, or
R⁶ and R⁷ together form a optionally substituted 4 to 8-membered cycloalkyl or heterocycloalkyl ring; or
one of R⁶ and R⁷ forms an optionally substituted 6 to 9-membered cycloalkyl or hetercycloalkyl ring fused with the phenyl ring.

The structure of formula (V) can be regarded as a tetrahydro-1H-benzo[f]isoindole-1,3(2H)-dione group, and may form a repeating structural backbone unit in the linear, sequence-defined backbone.

In some particular embodiments, cyclohexyl-linked backbone units in the linear backbone of the fluorescent macromolecule may have a structure of formula (Va):

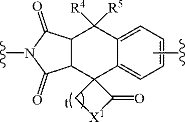

wherein:
R⁴ is OH,
R⁵ is selected from hydrogen, optionally substituted saturated or unsaturated C₁-C₂₂ alkyl, optionally substituted saturated or unsaturated C₁-C₂₂ heteroalkyl, optionally substituted aryl, optionally substituted heteroaryl, optionally substituted amino, and optionally substituted C₁-C₂₂ alkoxy,
X¹ is selected from O and NH; and
t is an integer in a range of from 1 to 4.

In some particular embodiments, cyclohexyl-linked backbone units in the linear backbone of the fluorescent macromolecule may have a structure of formula (Vb):

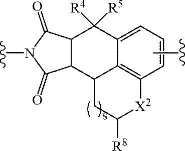

wherein:
R⁴ is OH,
R⁵ is selected from hydrogen, optionally substituted saturated or unsaturated C₁₋₂₂ alkyl, optionally substituted saturated or unsaturated C₁₋₂₂ heteroalkyl, optionally substituted aryl, optionally substituted heteroaryl, optionally substituted amino, and optionally substituted C₁₋₂₂ alkoxy,
X² is selected from O and NH;
R⁸ is carbonyl (═O); and
s is an integer in a range of from 0 to 3.

For avoidance of any doubt, when s=0 in structure Vb the relevant ring is intended to represent a 5-membered ring.

As discussed herein, the cyclohexyl-linked backbone units of the linear backbone may be derived from a heterobifunctional monomer having a first functional group providing a diene and a second functional group providing a dienophile.

In one form, the backbone units of the linear backbone may be derived from a heterobifunctional monomer having a maleimido functional group providing a dienophile, and a ortho-methyl benzaldehyde functional group that can be converted into an o-quinodimethane (a diene) moiety when irradiated by light.

In one embodiment, heterobifunctional monomers useful for forming the the macromolecule of the invention can comprise a fluorophore moiety. Such fluorophore-containing monomers may be described herein as “fluorophore heterobifunctional monomers”. Fluorophore heterobifunctional monomers can be covalently reacted and polymerised with other heterobifunctional monomers to form the fluorescent macromolecule of the invention. The fluorophore heterobifunctional monomers are incorporated into the linear backbone of the fluorescent macromolecule to provide fluorophore backbone units.

In another aspect, the present invention provides a fluorophore heterobifunctional monomer of formula (X):

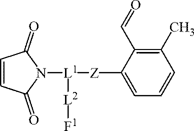

wherein:
Z is selected from O, N and S (preferably O or S);
L¹ is a first linker group that may be absent or present and when present, is selected from an optionally substituted linear or branched C₁ to C₄ saturated or unsaturated aliphatic group optionally comprising one or more heteroatoms selected from O, N and S;
L² is a second linker group selected from an optionally substituted saturated or unsaturated C₁ to C₁₆ aliphatic group, an optionally substituted aryl group, and an optionally substituted heteroaryl group, wherein said aliphatic, aryl or heteroaryl group optionally comprises at least one selected from a heteroatom selected from O, N and S and a divalent functional group; and
F¹ is a fluorophore.

In one set of embodiments, a fluorophore heterobifunctional monomer of formula (X) may have a structure of formula (Xa):

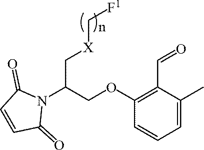

where:
F¹ is a fluorophore moiety;
X is O or NH;
n is an integer in the range of from 0 to 4.

Some specific examples of a fluorophore heterobifunctional monomer of formula (X) include the following:

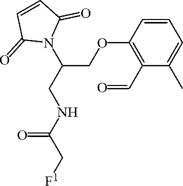

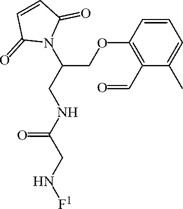

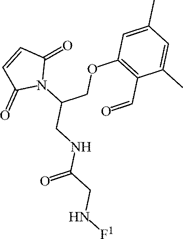

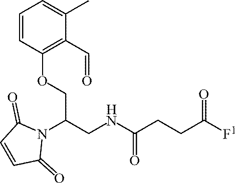

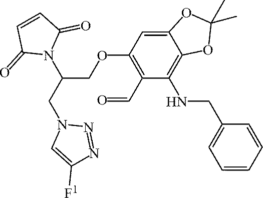

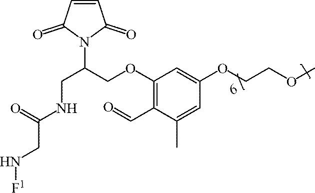

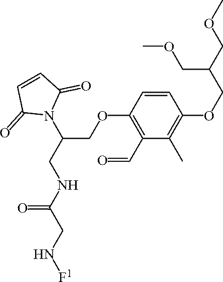

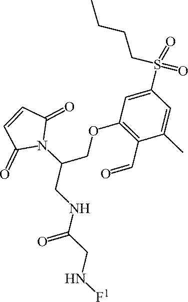

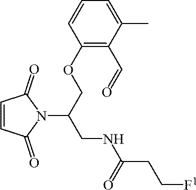

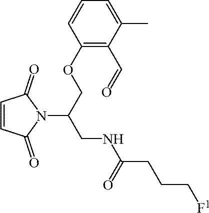

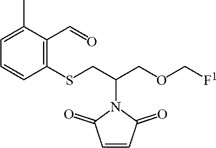

In another aspect, the present invention provides a fluorophore heterobifunctional monomer of formula (XI):

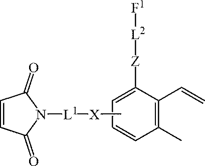

wherein:
Z is selected from O, N and S (preferably O or S);
X may be absent or present, and when present is a heteroatom selected from O, N and S;
L¹ is a first linker group that may be absent or present and when present, is selected from an optionally substituted linear or branched C₁ to C₄ saturated or unsaturated aliphatic group optionally comprising one or more heteroatoms selected from O, N and S;
L² is a second linker group selected from an optionally substituted saturated or unsaturated C₁ to C₁₆ aliphatic group, an optionally substituted aryl group, and an optionally substituted heteroaryl group, wherein said aliphatic, aryl or heteroaryl group optionally comprises at least one selected from a heteroatom selected from O, N and S and a divalent functional group; and
F¹ is a fluorophore.

Some specific examples of a fluorophore heterobifunctional monomer of formula (XI) include the following:

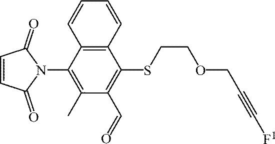

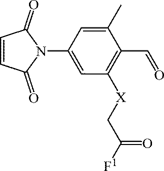

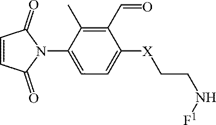

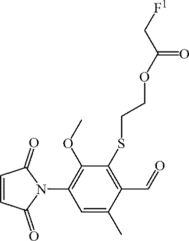

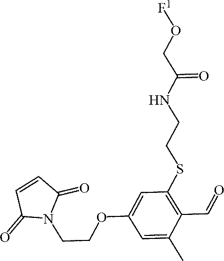

In another aspect, the present invention provides a fluorophore heterobifunctional monomer of formula (XII):

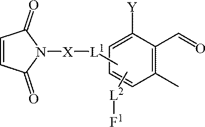

wherein:
Y is selected from OR⁹, NR⁹R¹⁰, SR⁹, S(O)R⁹, and S(O₂)R⁹;
R⁹ and R¹⁰ may each be independently selected from H, an optionally substituted saturated or unsaturated C₁-C₂₂ aliphatic group comprising one or more heteroatoms selected from O, N and S, an optionally substituted C₆ to C₁₂ cycloalkyl or fused polycycloalkyl, an optionally substituted aryl, and an optionally substituted heteroaryl;
X may be absent or present, and when present is a heteroatom selected from O, N and S;
L¹ is a first linker group that may be absent or present and when present, is selected from an optionally substituted linear or branched C₁ to C₄ saturated or unsaturated aliphatic group optionally comprising one or more heteroatoms selected from O, N and S;
L² is a second linker group selected from an optionally substituted saturated or unsaturated C₁ to C₁₆ aliphatic group, an optionally substituted aryl group, and an optionally substituted heteroaryl group, wherein said aliphatic, aryl or heteroaryl group optionally comprises at least one selected from a heteroatom selected from O, N and S and a divalent functional group; or
L² is a heterocycloalkyl group fused with the phenyl ring and F¹; and
F¹ is a fluorophore.

Some specific examples of a fluorophore heterobifunctional monomer of formula (XII) include the following:

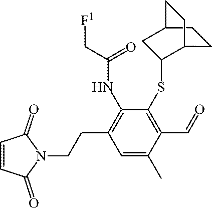

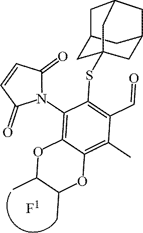

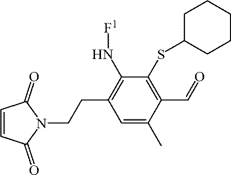

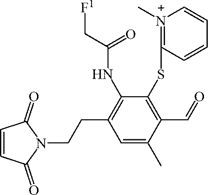

The monomers of formulae (X), (XI) and (XII) can be used for formation of the linear, sequence-defined backbone of the fluorescent macromolecule, and can provide a fluorophore backbone unit in the linear backbone.

Heterobifunctional monomers described herein may be prepared using conventional chemical procedures and techniques known to a skilled person. Illustrative procedures for synthesising the monomers are described in the Examples provided herein.

The present invention enables a library of fluorescent macromolecules to be formed using a photochemically driven iterative exponential growth (IEG) strategy involving fluorophore functionalised monomers.

A fluorescent macromolecule of the invention comprises a linear, sequence-defined backbone comprising a plurality of backbone units arranged in a predetermined sequence to encode information. The predetermined sequence of backbone units comprises a plurality of fluorophore backbone units in combination with at least one non-fluorophore backbone unit, preferably in combination with a plurality of non-fluorophore backbone units. In one preference, the linear backbone comprises at least one pair of fluorophore backbone units.

In one embodiment there may be provided a fluorescent macromolecule according to any of the embodiments described herein, wherein the backbone comprises backbone units arranged in a predetermined sequence to encode information, the sequence of backbone units comprising at least one non-fluorophore backbone unit, and a plurality of fluorophore backbone units, wherein the plurality of fluorophore backbone units optionally comprises a pair of fluorophore backbone units.

Non-fluorophore backbone units are preferably derived from a non-fluorophore heterobifunctional monomer, while fluorophore backbone units are preferably derived from a fluorophore heterobifunctional monomer. Examples of non-fluorophore and fluorophore heterobifunctional monomers are described herein. For ease of reference, fluorophore heterobifunctional monomers can be denoted herein as “M₁”, while non-fluorophore heterobifunctional monomers can be denoted as “M₀”.

A fluorophore backbone unit derived from a fluorophore monomer (M₁) can also be denoted herein as number “1” to indicate the presence of a fluorophore. Meanwhile, a non-fluorophore backbone unit derived from a non-fluorophore monomer (M₀) may be denoted by the number “0”, indicating the absence of a fluorophore. It would be appreciated that numbers used to denote a non-fluorophore or fluorophore backbone unit (i.e. “0” or “1”) are for illustration purposes only, and are not limiting.

In one embodiment, the fluorescent macromolecule comprises a pair of fluorophore backbone units, which provides a fluorophore pair in the macromolecule. A fluorophore pair can be denoted by the number sequence “11”, which indicates two fluorophores that are adj acent to one another. One example of a fluorophore pair that can provide a “11” sequence is shown below.

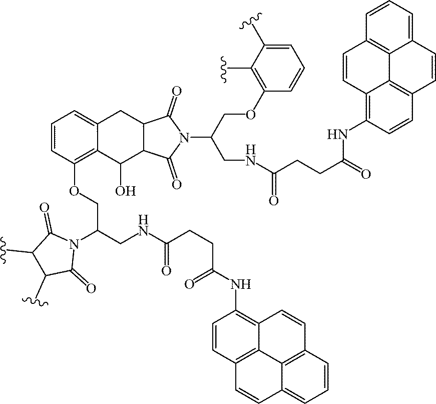

It would be appreciated that the fluorescent macromolecule may comprise other fluorophore pairs, involving different fluorophores and/or the use of different linking groups to attach a fluorophore to the linear backbone.

The fluorophore backbone units and non-fluorophore backbone units can be combined and arranged in any selected order to give a desired fluorophore sequence. For example, a group of 4 backbone units (i.e. a tetramer) in the fluorescent macromolecule might have fluorophore sequence as follows: 0001, 1100, 0111, 1111, 0101, 1010, 1110, 0110, and 1001.

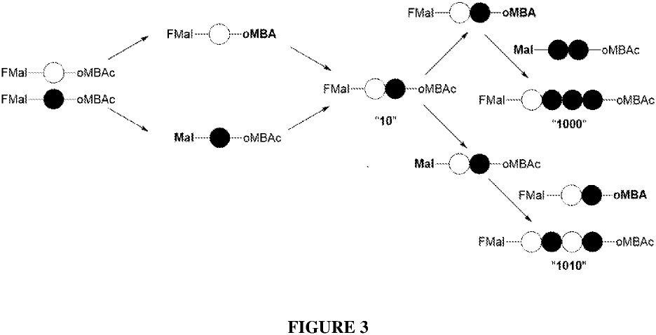

For example, tetramers having sequences of 1000 and 1010 are shown in FIG. 3. In the sequences shown in FIG. 3, the fluorophore in the sequence (denoted “1”) is not part of a fluorophore pair and is not next to another fluorophore. Such fluorophores may be considered to be single fluorophores in the fluorophore sequence, and may emit fluorescence at a different wavelength maximum and/or of different intensity than a fluorophore pair when irradiated by light. Fluorescence emitted by a single fluorophore within the fluorophore sequence may be described herein as “monomer fluorescence”.

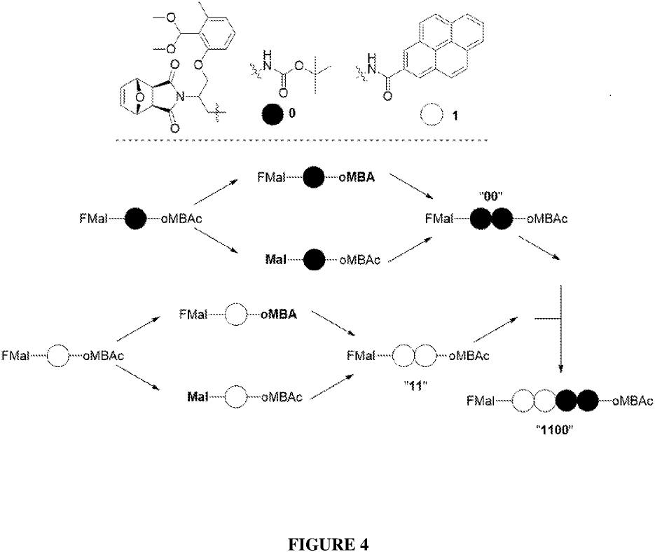

In another example, a tetramer having a sequence of 1100 is shown in FIG. 4. The sequence shown in FIG. 4 comprises a fluorophore pair (denoted “11”). In one preference, the fluorophore pair can emit excimer fluorescence.

A skilled person would appreciate that fluorophore sequences with a number of different combinations of fluorophores are possible. The number of possible fluorophore combinations in the fluorophore sequence might depend on the length of the linear, sequenced-defined backbone, and the type and quantity of fluorophores attached to the linear backbone.

A desired fluorophore sequence can be obtained by successively adding individual monomer units or blocks of monomer units (i.e. pre-formed oligomers) to a growing backbone chain. The present invention enables a fluorophore backbone unit to be incorporated at a precise location in the linear backbone by selecting when a fluorophore monomer is added to the backbone chain.

By selecting when fluorophore and non-fluorophore monomers (M₁ and M₀ monomers) are added to the growing backbone chain, a fluorophore sequence having a desired order of fluorophores can be constructed. This is due to the ability to control the introduction of fluorophores into the macromolecule, through the use of highly efficient and selective reactions for synthesis of the macromolecule. Thus it is possible to engineer the encoding of information into the macromolecule on a molecular level by controlling monomer addition to the linear backbone chain.

The fluorescent macromolecule of the invention emits fluorescence when irradiated by light. In one set of embodiments, the fluorescent macromolecule may be irradiated with ultraviolet (UV) or visible light.

Light useful for irradiating the fluorescent macromolecule may be obtained from a broad band light source. Alternatively, light useful for irradiating the fluorescent macromolecule may be monochromatic light generated with a LED and/or a filter.

After irradiation, fluorescence is emitted from the fluorescent macromolecule due to excitation of the fluorophores that are attached to the linear backbone of the macromolecule. The emitted fluorescence can be optically detected. The emitted fluorescence may be detected as RGB (red, green, blue) data with a RGB-chip. The RGB-raw data can then be converted into spectral data using RGB-responsivity curves.

Conventional equipment and techniques may be used for optical detection of the fluorescence emitted by the fluorescent macromolecule and for construction of a fluorescence spectrum. For example, an optical scanner may be used to detect the emitted fluorescence.

Advantageously, the use of optical methods to analyse the fluorophore sequence enables a faster, simpler, and more universally applicable method for elucidating the fluorophore sequence and hence the structure of the fluorescent macromolecule, to be achieved.

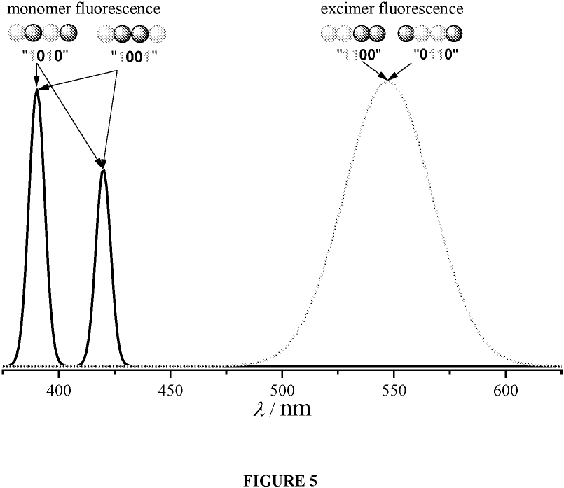

Different fluorophores within the fluorophore sequence may have different local electronic environments, which can influence the wavelength at which maximum fluorescence occurs, as well as the intensity of the emitted fluorescence. For example, it may be possible to distinguish between monomer and excimer fluorescence in a fluorescence spectrum, as excimer fluorescence may occur at a longer wavelength than that of monomer fluorescence. An example of monomer and excimer fluorescence is illustrated in FIG. 5.

Accordingly, the profile or shape of the fluorescence spectrum may reflect the environment surrounding a fluorophore and thus could provide information on the relative location of the fluorophore within a particular fluorophore sequence. As a result, the profile of the fluorescence spectrum may serve as a “fingerprint” for the sequence of fluorophores in the fluorescent macromolecule. This fingerprint reflects the distribution and order of fluorophores along the linear backbone of the fluorescent macromolecule.

The fluorophore sequence provides a unique fluorescent emission spectrum. The spectrum can examined and interpreted to reveal the underlying peaks that make up the spectrum. The spectrum can be deconvoluted to discriminate the individual peaks that make up the spectrum’s profile. Selected individual, characteristic peaks that are identified from the deconvoluted spectrum can be analysed and thereafter compared against a database containing an assignment of spectra from known, reference fluorophore sequences. The peak comparison and database matching allows the fluorophore sequence from a given sample to be determined. Determination of the fluorophore sequence can therefore enable information encoded by the macromolecule to be deciphered and read.

In another aspect, the present invention provides a method for encoding and retrieving information comprising the steps of:
providing a fluorescent macromolecule according to any one of the embodiments described herein, the macromolecule having predetermined sequence of fluorophores attached thereto to encode information;
irradiating the fluorescent macromolecule with light to obtain a fluorescence emission spectrum; and
analysing the fluorescence emission spectrum to determine the sequence of fluorophores and retrieve the encoded information.

In use, the fluorescent macromolecule of the invention may be incorporated into a composition. Accordingly, in another aspect, the present invention provides a composition comprising the fluorescent macromolecule of any one of the embodiments described herein. The composition may be of any suitable form, including liquid and solid compositions. In some embodiments, the composition may be a coating composition or a polymer composition. The fluorescent macromolecule may be present in the composition in a relatively low amount, such as in an amount of from about 10⁻⁶ to 10⁻⁸ mol/cm³. The composition may optionally comprise other components in addition to the fluorescent macromolecule.

Fluorescence emitted by the composition comprising the fluorescent macromolecule can be detected. In one preference, the emitted fluorescence is independent of the concentration of fluorescent macromolecule in the composition.

In one embodiment, a composition comprising the fluorescent macromolecule may be applied to or coated onto an article. For example, the fluorescent macromolecule may be incorporated in a coating composition that is applied to the surface of an article.

In another embodiment, a composition comprising the fluorescent macromolecule may be formed into an article. For example, the fluorescent macromolecule may be incorporated in a bulk material then an article is formed from the bulk material comprising the fluorescent macromolecule. In that way, the fluorescent macromolecule is incorporated into the structure of an article. The fluorescent macromolecule may be blended with a bulk material, such as for example, a bulk polymer material, to form a suitable composition.

When the fluorescent macromolecule is incorporated in an article, the fluorescence spectral profile provided by the macromolecule may be used to authenticate the article and thereby reduce the likelihood that consumers would be exposed to counterfeit articles. The fluorescence emitted by the fluorescent macromolecule is a unique identifier that is detectable using optical methods. In this application, the fluorescence spectrum can be deconvoluted to identify characteristic peaks in the spectrum. The deconvoluted peaks can be compared against an authentication code to authenticate the article. The presence of the fluorescent macromolecule in an article can therefore enable discrimination between genuine and non-genuine products and articles.

In another aspect, the present invention provides a method for determining the authenticity of an article, the method comprising the steps of:
providing an article comprising a fluorescent macromolecule according to any one of the embodiments described herein, the macromolecule having predetermined sequence of fluorophores attached thereto to encode information;
irradiating the article with light to obtain a fluorescence emission spectrum;
analysing the fluorescence emission spectrum to determine the sequence of fluorophores and retrieve the encoded information; and
comparing the retrieved information to an authentication code to authenticate the article.

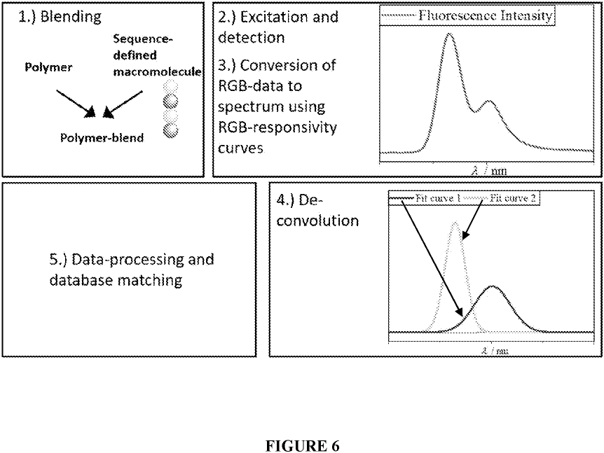

One example of a method for authenticating an article is shown in FIG. 6. As seen in FIG. 6, a fluorescent macromolecule having a known and pre-determined fluorophore spectrum can be blended with a bulk material, such as a coating composition, at low concentration (10⁻⁶ to 10⁻⁸ mol/cm⁻³). The coating composition can then be applied by a manufacturer to an article (step 1). The coated article can enter into a consumer marketplace. When a consumer or end-user wishes to determine if the article is genuine, the coated article can be irradiated by light, for example using light from a smart phone camera. Irradiation of the coated article causes the fluorophores in the fluorescent macromolecule to become excited and emit fluorescence. The emitted fluorescence can be detected and measured as raw RGB data with a RGB-chip (step 2). The raw RGB data is then converted into an RGB spectrum (step 3). The RGB spectrum has a characteristic profile, which is determined by individual peaks corresponding to different fluorescence maxima exhibited by different fluorophores within the macromolecule fluorophore sequence. The spectrum can be deconvoluted to identify characteristic peaks that make up the spectrum (step 4). The deconvoluted peaks can be analysed, and compared against reference peaks exhibited by a known, reference fluorophore sequence (step 5). The reference fluorophore sequence may represent an authentication code, against which the sample fluorophore sequence can be compared. If the sample fluorophore sequence matches the reference fluorophore sequence, the article may be authenticated.

The invention will now be described with reference to the following examples. However, it is to be understood that the examples are provided by way of illustration of the invention and that they are in no way limiting to the scope of the invention.

### EXAMPLES

### Chemicals and Materials

Chemicals were used as received without further purification if not stated otherwise: tert-butyl(oxiran-2-ylmethyl)carbamate (97%, Sigma-Aldrich), 2-hydroxy-6-methylbenzaldehyde (synthesized according to literature procedure, refer to Angew. Chem. Int. Ed. 2013, 52 (2), 762-766), 2-tert-Butylimino-2-diethylamino-1,3-dimethyl-perhydro-1,3,2-diazaphosphorine (BEMP, purum 98.0%, Sigma-Aldrich), trimethyl orthoformiate (TMOF, 99.8%, Merck), p-toluenesulfonic acid monohydrate (TsOH, 99.6%, Merck), 3α,4,7,7α-tetrahydro-1H-4,7-epoxyisoindole-1,3(2H)-dione (FMa1H, synthesized according to literature procedure, refer to Chem. Mater. 2008, 20(18), 5859-5868), diisopropyl azodicarboxylate (DIAD, 97% Merck), triphenylphosphine (PPh₃, 99% Chem-Supply), triethylamine (TEA, 99%, Chem-Supply), 1-hydroxy benzotriazole (HOBt, 99.5%, Merck), n-propyl amine (99%, Sigma-Aldrich), N,N-diisopropylethylamine (DIPEA, 99.5% Sigma-Aldrich), sodium sulfate (99.5%, Chem-Supply), N,N-Dimethylformamide (DMF, anhydrous 99.8%, Sigma-Aldrich), trifluroacetic acid (TFA, 99%, Alfa Aesar), 1-ethyl-3-(3-dimethylaminopropyl)carbodiimide (EDC, 98%, Sigma-Aldrich), acetonitrile (HPLC-grade, Fisher), dimethyl sulfoxide (DMSO, anhydrous 99.9%, Sigma-Aldrich), methanol (analytical reagent, Ajax Finechem), THF (analytical reagent, Fisher), chloroform (analytical reagent, Fisher), cyclohexane (CH, analytical reagent, Ajax Finechem), ethyl acetate (EE, analytical reagent, Fisher), dichloromethane (DCM, analytical reagent, Fisher), acetonitrile-d³ (99.8%D, Cambridge Isotope Laboratories), chloroform-d (99.8%D, Cambridge Isotope Laboratories), dimethylsulfoxide-d⁶ (99.9%D, Cambridge Isotope Laboratories).

### Instruments

### Bruker 600 MHz NMR

¹H- and ¹³C-spectra were recorded on a Bruker System 600 Ascend LH, equipped with a BBO-Probe (5 mm) with z-gradient (¹H: 600.13 MHz, ¹³C: 150.90 MHz,). All measurements were carried out in deuterated solvents. The chemical shift (δ) is recorded in parts per million (ppm) and relative to the residual solvent protons.² The measured coupling constants were calculated in Hertz (Hz). To analyze the spectra, the software MESTRENOVA 11.0 was used. The resonances are quoted as follows: s = singlet, bs = broad singlet, d = doublet, t = triplet, q = quartet, quin = quintet, dd = doublet of doublets and m = multiplet. Resonance assignments are based on COSY, HSQC and HMBC measurements.

### THF-SEC Measurements

The SEC measurements were conducted on a PSS SECurity² system consisting of a PSS SECurity Degasser, PSS SECurity TCC6000 Column Oven (35° C.), PSS SDV Column Set (8 x 150 mm 5 µm Precolumn, 8 x 300 mm 5 µm Analytical Columns, 100000 Å, 1000 Å and 100 Å) and an Agilent 1260 Infinity Isocratic Pump, Agilent 1260 Infinity Standard Autosampler, Agilent 1260 Infinity Diode Array and Multiple Wavelength Detector (A: 254 nm, B: 360 nm), Agilent 1260 Infinity Refractive Index Detector (35° C.). HPLC grade THF, stabilized with BHT, is used as eluent at a flow rate of 1 mL·min⁻¹. Narrow disperse linear poly(methyl methacrylate) ( M̅ₙ : 202 g·mol⁻¹ to 2.2×10⁶ g·mol⁻¹) standards (PSS ReadyCal) were used as calibrants. All samples were passed over 0.22 µm PTFE membrane filters. Molecular weight and dispersity analysis was performed in PSS WinGPC UniChrom software (version 8.2).

### LC-MS Measurements

LC-MS measurements were performed on an UltiMate 3000 UHPLC system (Dionex, Sunnyvale, CA, USA) consisting of a pump (LPG 3400SZ, autosampler WPS 3000TSL) and a temperature controlled column department (TCC 3000). Separation was performed on a C18 HPLC-column (Phenomenex Luna 5 µm, 100 Å, 250 × 2.0 mm) operating at 40° C. A gradient of ACN:H₂O 10:90 - 80:20 v/v (additive 10 mmol L⁻¹ NH₄CH₃CO₂) at a flow rate of 0.40 mL·min⁻¹ during 15 min was used as the eluting solvent. The flow was split in a 9:1 ratio, where 90% (0.18 mL·min⁻¹) of the eluent were directed through the UV-detector (VWD 3400, Dionex, detector wavelengths 215, 254, 280, 360 nm) and 10% (0.02 mL·min⁻¹) were infused into the electrospray source. Spectra were recorded on an LTQ Orbitrap Elite mass spectrometer (Thermo Fisher Scientific, San Jose, CA, USA) equipped with a HESI II probe. The instrument was calibrated in the m/z range 74-1822 using premixed calibration solutions (Thermo Scientific). A constant spray voltage of 3.5 kV, a dimensionless sheath gas and a dimensionless auxiliary gas flow rate of 5 and 2 were applied, respectively. The capillary temperature and was set to 300° C., the S-lens RF level was set to 68, and the aux gas heater temperature was set to 125° C.

### Fluorescence Spectroscopy

The fluorescence spectra and were measured using a Cary Eclipse Fluorescence Spectrophotometer from Agilent Technologies. Sample solutions were prepared in 10 mm quartz fluorescence cuvettes with septum caps and measured at ambient temperature. Solid samples were prepared on 1x10 cm glass slides via drop casting of the solution and removal of the respective solvent. Baseline measurements were performed on each of the relevant solvents and subtracted from the absorbance and fluorescence intensities.

### Flash Chromatography

Flash chromatography was performed on a Interchim XS420+ flash chromatography system consisting of a SP-in-line filter 20-µm, an UV-VIS detector (200-800 nm) and a SofTA Model 400 ELSD (55° C. dift tube temperature, 25° C. spray chamber temperature, filter 5, EDR gain mode) connected via a flow splitter (Interchim Split ELSD F04590). The separations were performed using a Interchim dry load column and a Interchim Puriflash Silica HP 30 µm column. The crude materials were deposited on celite 545 prior to chromatography.

### Preparative HPLC

Preparative HPLC was performed on an Interchim PF5.250 HPLC system consisting of a SP-in-line filter 20-µm, an UV-VIS detector (200-800 nm) and a Nano-IELSD (45° C. dift tube temperature) connected via a dynamic flow splitter flow splitter. The separations were performed using a direct injection via an injection valve and an Interchim Uptisphere Silica HP 5 µm column with 21.2 mm diameter and 250 mm length equipped with a pre-column filled with 5 µm silica.

### Monomer Synthesis

### Example 1

(Step 1) Synthesis of tert-butyl (3-(2-formyl-3-methylphenoxy)-2-hydroxypropyl)carbamate

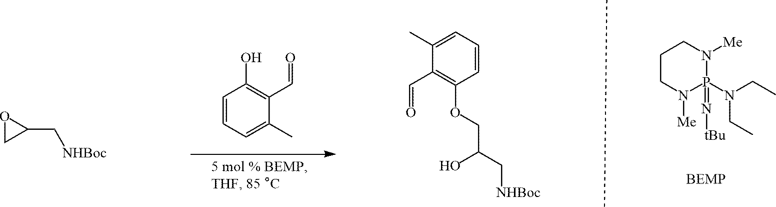

tert-butyl(oxiran-2-ylmethyl)carbamate (2.70 g, 15.60 mmol, 1.00 eq.) and 2-hydroxy-6-methylbenzaldehyde (2.23 g, 16.38 mmol, 1.05 eq.) were added to a flame dried schlenk flask under inert atmosphere. Afterwards BEMP (2-tert-Butylimino-2-diethylamino-1,3-dimethylperhydro-1,3,2-diazaphosphorine, 225.7 µL, 0.780 mmol, 5 mol%) was added via syringe, the components were dissolved in dry THF (35 mL) and the reaction mixture was heated to 85° C. for 15 h (reaction control via TLC and NMR). Upon full conversion of the phenol the reaction mixture was cooled to room temperature, the volatiles were removed and the crude product was purified by flash chromatography. (gradient DCM:MeOH 99:1-90:10 v/v). The product was obtained as yellowish oil, 4.29 g (89% yield).

¹H NMR (700 MHz, Chloroform-d) δ 10.61 (s, 1H), 7.47 - 7.32 (m, 1H), 6.83 (d, J = 8.0 Hz, 2H), 5.12 (s, 1H), 4.17 - 4.11 (m, 1H), 4.11 - 3.97 (m, 2H), 3.86 - 3.54 (m, 1H), 3.51 -3.40 (m, 1H), 3.37 - 3.21 (m, 1H), 2.65 - 2.49 (m, 3H), 1.49 - 1.39 (m, 9H). ¹³C NMR (176 MHz, CDCl₃) δ 191.87, 161.72, 157.43, 142.50, 134.79, 124.72, 123.60, 110.62, 80.17, 70.51, 70.02, 43.77, 28.46, 21.15.

(Step 2) Synthesis of tert-butyl (2-(1,3-dioxo-1,3,3a,4,7,7a-hexahydro-2H-4,7-epoxyisoindol-2-yl)-3-(2-formyl-3-methylphenoxy)propyl)carbamate

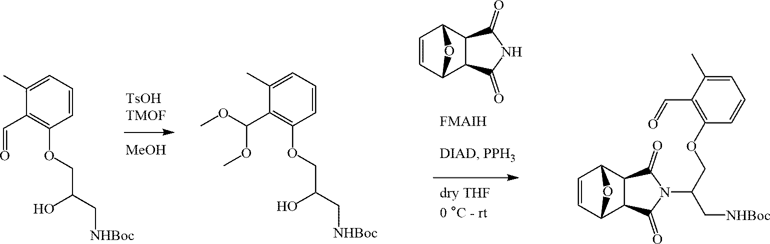

tert-butyl (3-(2-formyl-3-methylphenoxy)-2-hydroxypropyl)carbamate (2.10 g, 6.79 mmol, 1.00 eq.), TMOF (trimethyl orthoformiate, 2.97 mL, 2.88 g, 27.15 mmol, 4.00 eq.) and TsOH (p-toluenesulfonic acid, 93.51 mg, 0.543 mmol, ) were dissolved in dry MeOH (15 mL) under inert atmosphere. Afterwards the mixture was stirred overnight at 40° C. The crude product was purified via flash column chromatography (DCM:Et3N 95:5 v/v). The volatiles were removed and the crude tert-butyl (3-(2-(dimethoxymethyl)-3-methylphenoxy)-2-hydroxypropyl)carbamate was obtained in quantitative yield and used for the next step without further purification.

tert-butyl (3-(2-(dimethoxymethyl)-3-methylphenoxy)-2-hydroxypropyl)carbamate, FMa1H (3a,4,7,7a-tetrahydro-1H-4,7-epoxyisoindole-1,3(2H)-dione, 1.18 g, 7.13 mmol, 1.10 eq.) and PPh₃ (2.06 g, 10.18 mmol, 1.50 eq.) were added to a flame dried schlenk flask. THF (25 mL) was added under inert atmosphere via syringe and the solution was immersed into an ice bath. Afterwards a DIAD-solution (diisopropyl azodicarboxylate 1.92 g, 9.50 mmol, 1.40 eq., dissolved in 10 mL dry THF) was added via syringe during 1 h at 0° C., the reaction was stirred for additional 2 h at 0° C. and afterwards overnight at room temperature.

The volatiles were removed under reduced pressure, the crude product was dissolved in MeOH:H2O 99:1 v/v and 0.5 mL acetic acid were added. The mixture was stirred for 4 h, the volatiles were removed afterwards and the crude product was purified via flash chromatography (first gradient CH:EE 10:90- 50:50 v/v second, DCM:MeOH 97:3 v/v). The product was obtained as colorless crystalline material, 2.29 g (74% yield).

¹H NMR (600 MHz, Chloroform-d) δ 10.48 (s, 1H), 7.33 (t, J = 8.0 Hz, 1H), 6.80 (d, J = 7.7 Hz, 1H), 6.77 (d, J= 8.4 Hz, 1H), 6.50 (s, 2H), 5.25 (d, J= 22.8 Hz, 2H), 5.00 - 4.91 (m, 1H), 4.78 - 4.64 (m, 1H), 4.47 (t, J = 9.0 Hz, 1H), 4.29 (dd, J = 9.5, 5.6 Hz, 1H), 3.64 (dt, J = 15.2, 7.6 Hz, 1H), 3.61 - 3.52 (m, 1H), 2.89 - 2.79 (m, 2H), 2.53 (s, 3H), 1.41 (s, 9H).

¹³C NMR (151 MHz, Chloroform-d) δ 192.09, 176.74, 176.61, 161.65, 156.04, 142.24, 136.66, 136.52, 134.45, 124.82, 123.51, 110.02, 81.36, 81.27, 79.86, 65.42, 52.04, 47.36, 47.34, 39.11, 28.43, 21.54.

(Step 3) General procedure for the synthesis of monomers with a fluorophore attached thereto

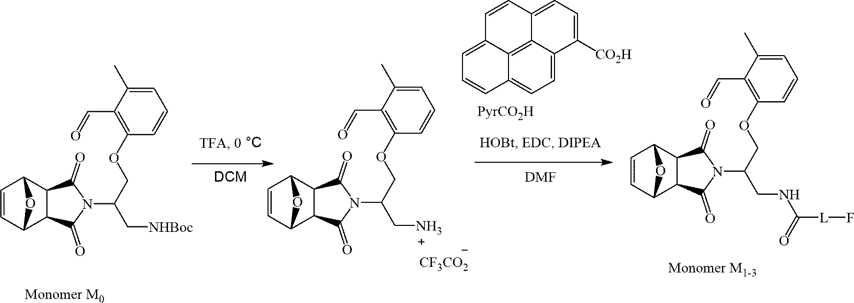

tert-butyl (2-(1,3-dioxo-1,3,3a,4,7,7a-hexahydro-2H-4,7-epoxyisoindol-2-yl)-3-(2-formyl-3-methylphenoxy)propyl)carbamate (Monomer M₀), 200 mg, 0.438 mmol, 1.00 eq.) was dissolved in dry DCM (6.7 mL) under inert atmosphere. Afterwards the schlenk-flask was immersed into an ice bath and dry TFA (1342 µL, 1888 mg, 17.52 mmol, 40.00 eq.) was added via syringe. The reaction mixture was stirred at 0° C. for 2.5 h and the volatiles were subsequently removed under reduced pressure at 0° C. bath temperature (ice-bath).

In the second step, the deprotected monomer M₀ (2-(1,3-dioxo-1,3,3a,4,7,7a-hexahydro-2H-4,7-epoxyisoindol-2-yl)-3-(2-formyl-3-methylphenoxy)propan-1-aminium 2,2,2-trifluoroacetate, 117.60 mg, 0.478 mmol, 1.09 eq.), the fluorophore-linker carboxylic acid (F₁₋₃-L-COOH, 1.25 eq.) and HOBt (65.12 mg, 0.482 mmol, 1.10 eq.) were dissolved in N,N-dimethylformamide (13 mL) and the mixture placed on an ice bath. 1-ethyl-3-(3-dimethylaminopropyl)carbodiimide (96.58 mg, 0.504 mmol, 1.15 eq.) and afterwards N,N-diisopropylethylamine (228.6 µL, 169.9 mg, 1.314 mmol, 3.0 eq., dissolved in 5 mL dry DMF) were added via a syringe during 20 min. The reaction mixture is stirred at 0° C. for 2 h and subsequently over night at ambient temperature. The reaction mixture is diluted in 100 ml ethyl acetate, washed with twice with 25 ml 1 N HCl, twice with 25 ml saturated NaHCO₃-solution and finally with 40 ml brine. The organic layer is dried over Na₂SO₄ and the solvent is removed in vacuo. The crude product is purified via flash chromatography (gradient CH:EE 30:70-90:10 v/v).

Monomer 1 N (2-(1,3-dioxo-1,3,3α,4,7,7α-hexahydro-2H-4,7-epoxyisoindol-2-yl)-3-(2-formyl-3-methylphenoxy)propyl)pyrene-1-carboxamide

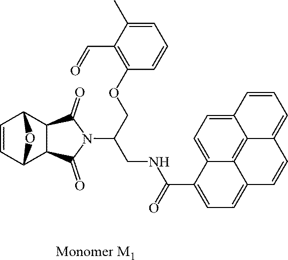

1-Pyrenecarboxylic acid (Fi-L-COOH) was used. The product was obtained as yellowish crystalline needles in 81% yield).

¹H NMR (600 MHz, DMSO-d₆) δ 10.39 (d, J = 0.6 Hz, 1H), 8.91 (t, J = 6.0 Hz, 1H), 8.47 (d, J= 9.2 Hz, 1H), 8.36 (d, J= 7.0 Hz, 2H), 8.32 (d, J= 7.9 Hz, 1H), 8.28 - 8.20 (m, 3H), 8.12 (t, J = 7.6 Hz, 1H), 8.09 (d, J = 7.9 Hz, 1H), 7.48 (dd, J = 8.4, 7.6 Hz, 1H), 7.07 (d, J= 8.4 Hz, 1H), 6.88 (dd, J = 7.6, 0.9 Hz, 1H), 6.54 (dd, J = 5.7, 1.7 Hz, 1H), 6.52 (dd, J = 5.8, 1.7 Hz, 1H), 5.11 (dd, J = 6.3, 1.3 Hz, 2H), 4.82 (tt, J = 8.8, 5.4 Hz, 1H), 4.59 - 4.51 (m, 2H), 4.02 (dt, J = 13.4, 5.7 Hz, 1H), 3.83 (ddd, J = 13.7, 8.6, 5.6 Hz, 1H), 2.96 (d, J = 6.5 Hz, 1H), 2.92 (d, J= 6.6 Hz, 1H), 2.45 (s, 3H).

¹³C NMR (151 MHz, DMSO-d6) δ 191.85, 177.05, 176.86*, 169.26, 161.54, 140.59, 136.52, 136.44*, 134.81, 131.68, 131.43, 130.68, 130.17, 128.37, 128.10, 127.79, 127.18, 126.60, 125.83, 125.65, 125.25, 124.64, 124.37, 124.22, 123.74, 123.58, 122.74, 110.66, 80.58, 80.43*, 65.49, 51.04, 47.12, 47.01*, 37.24, 20.95. (Signals marked * are a result of the rotations barrier in the molecule for the furan protected maleimide group.)

HRMS [M+H]⁺; C₃₇H₃₁N₂O₆⁺; calculated: 599.2177, found: 599.2168.

Monomer 2 Dimethyl 5-((3-(-2-(-1,3-dioxo-1,3,3a,4,7,7,a-hexahydro-2H-4,7-epoxyisoindol-2-yl)-3-(2-formyl-3-methylphenoxy)propyl)amino)-3-oxopropyl)thio)naphthalene-2,3-dicarboxylate

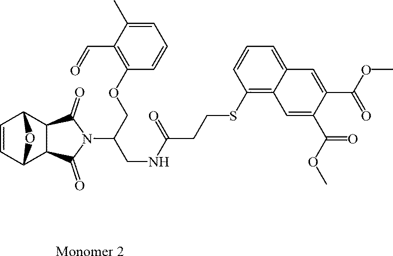

3-((6,7-bis(methoxycarbonyl)naphthalen-1-yl)thio)propanoic acid (F₂-L-COOH)was used. The product was obtained as slightly yellow crystalline solid, 76% yield).

¹H NMR (600 MHz, Chloroform-d) δ 10.43 (s, 1H), 8.75 (s, 1H), 8.22 (s, 1H), 7.79 (d, J = 8.1 Hz, 1H), 7.72 (d, J = 7.4 Hz, 1H), 7.60 - 7.49 (m, 1H), 7.30 (t, J = 7.7 Hz, 1H), 6.78 (d, J = 7.6 Hz, 1H), 6.75 (d, J = 8.4 Hz, 1H), 6.46 (s, 2H), 6.32 (s, 1H), 5.22 (s, 1H), 5.13 (s, 1H), 4.70 (td, J = 8.2, 4.1 Hz, 1H), 4.41 (t, J = 8.8 Hz, 1H), 4.29 (dd, J = 9.4, 5.9 Hz, 1H), 3.95 (dd, J = 3.4, 1.1 Hz, 6H), 3.87 (dt, J = 14.8, 7.6 Hz, 1H), 3.68 (dt, J = 14.0, 5.3 Hz, 1H), 3.25 (ddt, J = 29.7, 13.5, 7.1 Hz, 2H), 2.88 - 2.78 (m, 2H), 2.52 (s, 3H), 2.45 (t, J = 7.1 Hz, 2H).

13C NMR (151 MHz, Chloroform-d) δ 191.87, 176.69, 176.65*, 171.19, 168.35, 167.96, 161.18, 142.44, 136.48, 134.81, 134.59*, 134.18, 133.50, 131.10, 130.85, 129.17, 128.83, 128.50, 128.04, 127.37, 124.85, 123.36, 110.09, 81.37, 65.62, 52.96, 52.88, 51.46, 47.38, 47.31*, 38.14, 35.93, 30.39, 21.30. (Signals marked * are a result of the rotations barrier in the molecule for the furan protected maleimide group.)

HRMS [M+H]⁺; C₃₆H₃₅N₂O₁₀S⁺; calculated: 687.2007, found: 687.1990.

Monomer 3 N-(-2-(-1,3-dioxo-1,3,3a,4,7,7a-hexahydro-2H-4,7-epoxyisoindol-2-yl)-3-(2-formyl-3-methylphenoxy)propyl)-3-(1,3-dioxo-1H-benzo[de]isoquinolin-2(3H)-yl)propanamide

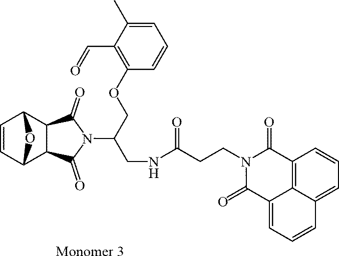

3-(1,3-dioxo-1H-benzo[de]isoquinolin-2(3H)-yl)propanoic acid (F₁-L-COOH) was used. The product was obtained as beige solid in 61% yield).

¹H NMR (600 MHz, Chloroform-d) δ 10.41 (s, 1H), 8.55 (dd, J = 7.3, 1.1 Hz, 2H), 8.17 (d, J = 7.6 Hz, 2H), 7.71 (t, J = 7.7 Hz, 2H), 7.31 (t, J = 8.0 Hz, 1H), 6.77 (dd, J = 12.0, 8.0 Hz, 2H), 6.62 (t, J = 6.2 Hz, 1H), 6.56 - 6.44 (m, 2H), 5.30 (d, J = 1.5 Hz, 1H), 5.26 (d, J = 1.5 Hz, 1H), 4.71 (tt, J = 8.2, 5.6 Hz, 1H), 4.52 - 4.39 (m, 3H), 4.27 (dd, J = 9.5, 5.6 Hz, 1H), 3.87 - 3.71 (m, 2H), 2.96 - 2.78 (m, 2H), 2.65 (t, J = 7.6 Hz, 2H), 2.51 (s, 3H).

13C NMR (151 MHz, Chloroform-d) δ 192.00, 176.79, 176.71*, 171.07, 164.27, 161.36, 142.32, 136.60, 136.51, 134.55, 134.21*, 131.67, 131.47, 128.24, 127.05, 124.76, 123.34, 122.57, 110.12, 81.38, 81.35*, 51.59, 47.43, 47.39, 38.05, 36.86, 35.00, 21.39. (Signals marked * are a result of the rotations barrier in the molecule for the furan protected maleimide group.)

HRMS: [M+H]⁺; C₃₄H₃₀N₃O₈⁺; calculated: 608.2027, found: 608.2025.

### Example 2

(Step 1) Synthesis of N-(3,4-dimethyl-2-nitrophenyl)acetamide

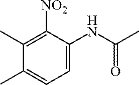

To a solution of 3,4-Dimethylacetanilide (5 g, 33.5 mmol, 1.00 eq) mixed solvent of 16 mL acetic acid and 16 mL acetic anhydride at 0° C., 65% nitric acid (3.0 mL, 43.5 mmol, 1.3 equiv.) was added dropwise. This mixture was stirred overnight at room temperature and then poured onto crushed ice, extracted with ethyl acetate. The combined extracts were washed with aqueous NaHCO₃ and brine, dried, concentrated, and purified by flash chromatography (silica gel, gradient 90:10- 50:50 ethyl acetate/hexanes v/v) to provide N-acetyl-2-methyl-6-nitrophenylamine (5.1 g, 78.3% yield).

¹H NMR (600 MHz, Chloroform-d) δ 10.29 (s, 1H), 8.53 (s, 1H), 7.97 (s, 1H), 2.34 (s, 3H), 2.28 (s, 3H), 2.27 (s, 3H).

¹³C NMR (151 MHz, Chloroform-d) δ 169.07, 147.00, 134.31, 132.89, 132.50, 126.04, 122.80, 25.78, 20.67, 19.28.

(Step 2) Synthesis of N-(3-formyl-4-methyl-2-nitrophenyl)acetamide

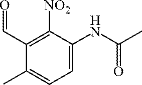 [SMILES: CC(=O)Nc1ccc(C)c(C=O)c1[N+](=O)[O-]]

To a stirred solution of N-(3,4-dimethyl-2-nitrophenyl)acetamide (1.60 g, 7.684 mmol, 1.00 eq) in 19.1 mL N,N-dimethylformamide, N,Ndimethylformamide dimethylacetal (3.06 mL, 2.75 g, 23.05 mmol, 3.00 eq) was added. The reaction mixture was stirred at 85° C. for 72 h. The reaction was monitored by TLC (EE:CH 1:10 v/v) and ¹H-NMR in acetonitrile-d³. After full conversion of the starting material the reaction mixture was cooled to ambient temperature. A solution of NaIO₄ (5.34 g, 24.97 mmol, 3.25 eq.) in H₂O (4.7 mL) and DMF (4.7 mL) was prepared at 45° C. The solution was rapidly cooled using an ice bath and the reaction mixture from the previous step was added rapidly via syringe. Afterwards the resulting suspension was stirred for ½ h at 0° C. and afterwards 3 h at room temperature. Then the mixture was diluted with ethyl acetate, filtrated, the filter cake washed with ethyl acetate and the filtrate washed with H₂O (3 x 25 mL) and brine solution (3 x 25 mL). The organic layer was dried over Na₂SO₄ and concentrated after filtration under reduced pressure. Purification by flash chromatography (silica gel, gradient 80:20- 30:70 ethyl acetate/hexanes v/v) provided the product as beige solid (1.70 g, 87% yield).

¹H NMR (600 MHz, Chloroform-d) δ 10.24 (s, 1H), 10.08 (s, 1H), 9.18 (s, 1H), 8.07 (s, 1H), 2.66 (s, 3H), 2.31 (s, 3H).

¹³C NMR (151 MHz, Chloroform-d) δ 191.86, 169.14, 138.86, 138.07, 134.75, 132.91, 128.52, 127.64, 25.62, 19.45.

(Step 3) Synthesis of 3-amino-6-methyl-2-nitrobenzaldehyde

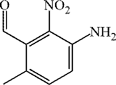

N-(3-formyl-4-methyl-2-nitrophenyl)acetamide (1.70 g, 7.65 mmol, 1.00 eq.), was dissolved in 48 mL MeOH and 25% HCl (45 mL) were added. The solution was degassed by passing through nitrogen for 30 min and then the solution was heated to 80° C. for 12 h under inert atmosphere. Afterwards the volatiles were removed under reduced pressure and product as obtained as orange crystal needles (1.38 g, 99% yield).

¹H NMR (600 MHz, DMSO-d6) δ 10.14 (s, 1H), 7.89 (s, 1H), 7.48 (s, 1H), 7.41 (s, 2H), 2.46 (s, 3H).

¹³C NMR (151 MHz, DMSO-d6) δ 192.89, 144.02, 138.96, 127.33, 124.59, 122.97, 17.48.

(Step 4) Synthesis of 3-(2,5-dioxo-2,5-dihydro-1H-pyrrol-1-yl)-6-methyl-2-nitrobenzaldehyde

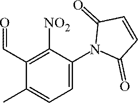 [SMILES: Cc1ccc(N2C(=O)C=CC2=O)c([N+](=O)[O-])c1C=O]

In a flame-dried Schlenk tube, maleic anhydride (746.5 mg, 7.613 mmol, 1.01 eq.) was dissolved in 15 mL dry 1,4-dioxane. 3-amino-6-methyl-2-nitrobenzaldehyde (1.380 g, 7.61 mmol, 1.00 eq.) was added to the tube and the solution was degassed by passing through a stream of nitrogen for 15 min. Afterwards, the solution was heated at 105° C. for 96 h. Then ⅔ of the dioxane was removed under high vacuum and 30 mL of dry acetic acid were added. The solution was degassed by passing through a stream of nitrogen for 15 min and heated at 125° C. again. Afterwards, the acetic acid was removed under high vacuum and the crude product was purified via flash chromatography (silica gel, gradient DCM:MeOH 99:1-90:10 v/v. The product was obtained as beige solid (636 mg, 59% yield).

¹H NMR (600 MHz, Acetonitrile-d3) δ 10.33 (s, 1H), 8.06 (s, 1H), 7.91 (s, 1H), 7.03 (s, 2H), 2.77 (s, 3H).

¹³C NMR (151 MHz, Acetonitrile-d₃) δ 191.55, 169.78, 144.07, 138.67, 136.28, 132.54, 129.91, 129.70, 123.75, 18.75.

(Step 5) Synthesis of 3-(1,3-dioxo-1,3,3a,4,7,7a-hexahydro-2H-4,7-epoxylsoindol-2-yl)-6-methyl-2-nitrobenzaldehyde

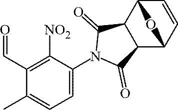 [SMILES: Cc1ccc(N2C(=O)[C@@H]3[C@H](C2=O)[C@H]2C=C[C@@H]3O2)c([N+](=O)[O-])c1C=O]

Furane (603 µL, 949 mg, 5.77 mmol, 3.00 eq.) was added to a solution of 3-(2,5-dioxo-2,5-dihydro-1H-pyrrol-1-yl)-6-methyl-2-nitrobenzaldehyde (500 mg, 1.92 mmol, 1.00 eq.) in 75 mL toluene and the mixture heated at 80° C. for 18 h. Afterwards the volatiles were removed under reduced pressure and the crude product was purified via flash chromatography (silica gel, gradient DCM:MeOH 98:2-90: 10 v/v). The product was obtained as a beige crystalline solid (573 mg, 91%).

¹H NMR (600 MHz, Chloroform-d) δ 10.31 (s, 1H), 8.04 s, 1H), 7.82 (s, 1H), 6.59 (d, J = 0.9 Hz, 2H), 5.52 - 5.33 (m, 2H), 3.11 (s, 2H), 2.79 (s, 3H).

¹³C NMR (151 MHz, Chloroform-d) δ 189.70, 174.25, 147.22, 143.15, 136.86, 133.32, 128.97, 123.76, 81.49, 48.18, 19.40.

HRMS: [M+Na]⁺; C₁₆H₁₂N₂NaO₆+ calculated: 351.0588, found: 351.0585.

(Step 6) Synthesis of 3-(-1,3-dioxo-1,3,3a,4,7,7a-hexahydro-2H-4,7-epoxyisoindol-2-yl)-2-(dodecylthio)-6-methylbenzaldehyde

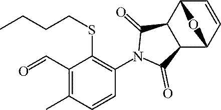 [SMILES: CCCCSc1c(N2C(=O)[C@@H]3[C@H](C2=O)[C@H]2C=C[C@@H]3O2)ccc(C)c1C=O]

A dry Schlenk roundbottom flask was charged with 3-(1,3-dioxo-1,3,3a,4,7,7a-hexahydro-2H-4,7-epoxyisoindol-2-yl)-6-methyl-2-nitrobenzaldehyde (50 mg, 0.152 mmol, 1.00 eq), 1-butyl thiol (16.48 mg, 19.58 µL, 0.183 mmol, 1.20 eq.) and the mixture was dissolved in dry ACN (2.75 mL) under argon atmosphere. Triethylamine (38.53 mg, 53.07 µL, 0.381 mmol, 2.50 eq.) was added and the reaction solution degassed by passing through a stream of nitrogen for 10 min. Afterwards the reaction mixture was heated to 55° C. for 16 h protected from light. The reaction mixture was cooled to ambient temperature, the volatiles were removed under reduced pressure and finally the product was purified via flash column chromatography (silica gel, gradient CH:EE 80:20-50:50 v/v). The product was obtained as slightly yellow solid (52.1 mg, 92%).

HRMS: [M+H]⁺; C₂₀H₂₂NO₄S⁺ calculated: 372.1270, found: 372.1264

The NMR spectra reflect the rotation barrier of the C_{Ar}-N bond leading to a two sets of signals.

### Rotamer 1

¹H NMR (600 MHz, Acetonitrile-d₃) δ 10.16 (s, 1H), 7.54 (s, 1H), 7.31 (d, J= 0.9 Hz, 1H), 6.57 (t, J= 0.9 Hz, 2H), 5.24 (t, J= 0.9 Hz, 2H), 3.01 (s, 2H), 3.00 - 2.95 (m, 2H), 2.68 (s, 3H), 1.66 - 1.53 (m, 2H), 1.48 - 1.38 (m, 2H), 0.92 (t, J= 7.4, 3H).

¹³C NMR (151 MHz, Acetonitrile-d3) δ 191.73, 176.30, 146.15, 143.30, 137.68, 132.35, 131.40, 130.04, 129.56, 81.95, 49.15, 31.89, 31.27, 22.58, 13.84.

### Rotamer 2

¹H NMR (600 MHz, Acetonitrile-d3) δ 10.13 (s, 1H), 7.36 (d, J = 0.8 Hz, 1H), 7.34 (s, 1H), 6.5kk8 (t, J = 1.0 Hz, 2H), 5.28 (t, J = 0.9 Hz, 2H), 3.12 (s, 2H), 3.05 - 3.02 (m, 2H), 2.68 (s, 3H), 1.68 - 1.51 (m, 2H), 1.50 - 1.35 (m, 2H), 0.92 (t, J = 7.4, 3H).

¹³C NMR (151 MHz, Acetonitrile-d₃) δ 191.81, 176.38, 145.47, 143.52, 137.62, 132.55, 131.35, 130.31, 129.31, 82.58, 48.71, 32.04, 31.27, 22.56, 19.25, 13.81.

### Oligomer Synthesis

### GP 1 General Procedure for the Transformation of FMAI-oMBA-monomers Into Mal-oMBAc-Monomers

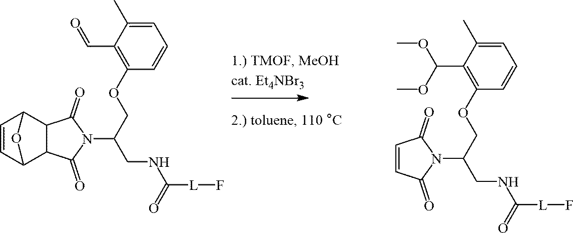

FMAl-oMBA monomer (1.00 eq.) is dissolved in toluene (5 mg mL⁻¹), degassed by passing through N₂ for 10 min and heated to 100° C. for 16 h. Afterwards, the toluene is removed, the residue is dissolved in MeOH (5 mg mL⁻¹), TMOF (8.00 eq.) and Et₄NBr₃ (0.02 eq.) is added and the reaction mixture is stirred for 2 h. Afterwards the MeOH-solution is added to a mixture of 0.1N NaHCO₃ with toluene containing 1% DIEPA (1:2 v/v). The organic phase is separated, the aqueous phase extracted a second time with toluene containing 1% DIPEA, the combined organic phase is washed with brine and dried over Na₂SO₄. Afterwards the suspension is filtered, the filtrate concentrated and dried under high vacuum. The residual intermediate is used for the photoligation reaction without further purification (quantitative yield).

### GP 2 General Procedure for the Photoligation of a FMal-oMBA-monomers With Mal-oMBAc-monomers yielding a FMal-oMBA-dimer

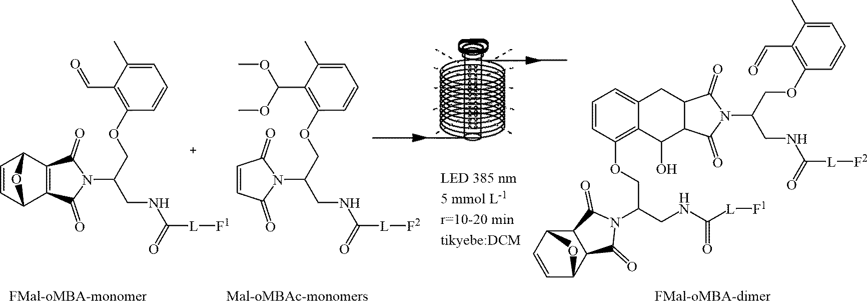

FMal-oMBA-monomer (1.05 eq.) and Mal-oMBA-monomer (1.00 eq.) are dissolved in toluene:DCM 1:1 (v/v) containing 0.1% DIPEA (5 mmol L⁻¹). The solution is degassed by passing through nitrogen for 15 min. The solution is irradiated in a photoflow reactor (PFA-tube 0.004” bore size, 1/16″ diameter, retention time 10-20 min, irradiation with 10 W 385 nm Luminous Devices SMB-120-UV, 4 cm distance). The acetal protecting group is removed by stirring with acetic acid 1% in water:MeOH 3:97 v/v. The crude product is purified via preparative HPLC.

### Example 3

Synthesis of tert-butyl (2-(5-(2-(-1,3-dioxo-1,3,3a,4,7,7a-hexahydro-2H-4,7-epoxyisoindol-2-yl)-3-(2-(pyren-1-yl)acetamido)propoxy)-4-hydroxy-1,3-dioxo-1,3,3a,4,9,9a-hexahydro-2H-benzo[f]isoindol-2-yl)-3-(2-formyl-3-methylphenoxy)propyl)carbamate

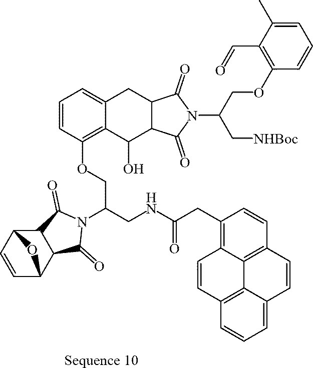

The product was obtained employing GP1 and GP2 as beige solid (82% yield) after preparative HPLC purification (73:25:2-70:28:2 hexanes:ethyl acetate:methanol v/v/v).

¹H NMR (600 MHz, Chloroform-d) δ 10.51 (s, 1H), 8.23 - 8.11 (m, 5H), 8.11 - 8.01 (m, 3H), 7.90 (d, J = 7.7 Hz, 1H), 7.33 (t, J = 8.0 Hz, 1H), 6.98 (t, J = 8.1 Hz, 1H), 6.82 - 6.73 (m, 3H), 6.41 (d, J = 8.3 Hz, 1H), 6.20 - 6.07 (m, 2H), 5.75 - 5.66 (m, 1H), 5.40 (dd, J = 10.1, 4.0 Hz, 1H), 5.18 - 5.03 (m, 2H), 4.84 (d, J = 20.8 Hz, 1H), 4.80 - 4.73 (m, 1H), 4.50 (qd, J = 9.5, 9.0, 4.1 Hz, 2H), 4.34 - 4.23 (m, 3H), 4.10 (t, J = 9.5 Hz, 1H), 3.91 (dd, J = 9.7, 5.1 Hz, 1H), 3.77 (ddd, J = 15.0, 9.0, 6.6 Hz, 1H), 3.67 - 3.56 (m, 2H), 3.53 (dt, J = 14.3, 5.2 Hz, 1H), 3.13 - 2.98 (m, 4H), 2.86 - 2.76 (m, 1H), 2.53 (s, 3H), 1.97 - 1.91 (m, 2H), 1.43 - 1.27 (m, 9H).

¹³C NMR (151 MHz, Chloroform-d) δ 192.15, 180.18, 177.78, 176.53, 175.89, 171.59, 161.84, 156.15, 153.72, 142.22, 138.29, 136.08, 135.96, 134.43, 134.33, 131.41, 131.24, 130.83, 129.54, 129.50, 129.38, 128.73, 128.69, 128.40, 127.77, 127.57, 127.11, 126.49, 126.01, 125.75, 125.73, 125.61, 125.46, 125.23, 124.76, 124.66, 123.56, 123.10, 121.48, 110.09, 109.74, 80.95, 80.72, 79.55, 65.86, 65.47, 64.08, 64.00, 60.90, 51.60, 51.14, 51.06, 46.70, 46.49, 46.03, 42.20, 38.43, 37.84, 37.44, 31.58, 30.45, 30.34, 29.84, 28.48, 28.47, 27.60, 21.60, 21.58.

HRMS: [M+H]⁺; C₅₇H₅₅N₄O₁₂⁺ calculated: 987.3811, found: 987.3798.

Synthesis of tert-butyl (2-((3aR,4S,7R,7aS)-1,3-dioxo-1,3,3a,4,7,7a-hexahydro-2H-4,7-epoxyisoindol-2-yl)-3-((2-(1-(2-formyl-3-methylphenoxy)-3-(2-(pyren-1-yl)acetamido)propan-2-yl)-4-hydroxy-1,3-dioxo-2,3,3a,4,9,9a-hexahydro-1H-benzo[f]isoindol-5-yl)oxy)propyl)carbamate

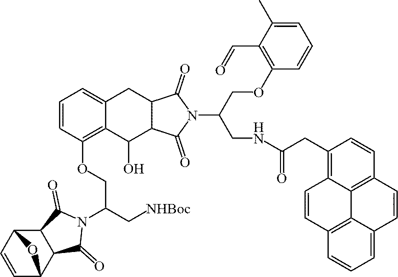 [SMILES: Cc1cccc(OCC(CNC(=O)Cc2ccc3ccc4cccc5ccc2c3c45)N2C(=O)C3Cc4cccc(OCC(CNC(=O)OC(C)(C)C)N5C(=O)[C@@H]6[C@H](C5=O)[C@H]5C=C[C@@H]6O5)c4C(O)C3C2=O)c1C=O]

The product was obtained employing GP1 and GP2 as beige solid (76% yield) after preparative HPLC purification (73:25:2-70:28:2 hexanes:ethyl acetate:methanol v/v/v). The product was obtained as a isomeric mixture of endo and exo-Diels-Alder reaction, resulting in additional signals in the ¹³C-NMR spectrum.

1H NMR (600 MHz, Chloroform-d) δ 10.43 (s, 1H), 8.16 (d, J = 7.6 Hz, 1H), 8.11 (t, J = 6.3 Hz, 3H), 7.99 (t, J = 7.6 Hz, 1H), 7.94 (d, J = 7.7 Hz, 1H), 7.89 (d, J = 8.9 Hz, 1H), 7.79 (dd, J = 10.7, 8.3 Hz, 2H), 7.22 (t, J = 8.0 Hz, 1H), 7.13 (t, J = 7.9 Hz, 1H), 6.74 (d, J = 7.6 Hz, 1H), 6.65 (dd, J = 14.2, 8.4 Hz, 2H), 6.50 (d, J = 7.6 Hz, 1H), 6.40 - 6.34 (m, 1H), 6.26 (dd, J = 5.9, 1.6 Hz, 1H), 6.11 (dd, J = 8.1, 4.5 Hz, 1H), 5.27 (d, J = 1.7 Hz, 1H), 5.17 (d, J = 3.9 Hz, 1H), 4.94 (s, 1H), 4.89 (s, 1H), 4.65 (tt, J = 9.4, 4.6 Hz, 1H), 4.58 (s, 1H), 4.42 (t, J = 9.1 Hz, 1H), 4.30 (t, J = 9.4 Hz, 1H), 4.20 (dd, J = 15.9, 5.7 Hz, 3H), 4.16 - 4.12 (m, 1H), 3.99 (ddd, J = 12.3, 7.9, 3.8 Hz, 1H), 3.66 (dd, J = 13.9, 7.0 Hz, 1H), 3.57 (ddd, J = 14.3, 10.3, 4.5 Hz, 1H), 3.49 (s, 3H), 2.85 - 2.71 (m, 3H), 2.66 (dd, J = 15.3, 9.4 Hz, 1H), 2.49 (s, 3H), 2.25 (dd, J = 34.3, 4.5 Hz, 1H), 1.41 (s, 9H).

¹³C NMR (151 MHz, Chloroform-d) δ 191.97, 179.91, 177.62, 176.68, 171.47, 161.62, 156.07, 153.72, 142.20, 137.63, 136.47, 136.34, 134.36, 131.33, 130.91, 129.72, 129.57, 128.84, 128.47, 128.26, 127.57, 127.13, 126.26, 125.57, 125.43, 125.12, 124.97, 124.94, 124.78, 124.59, 123.52, 123.21, 121.53, 110.05, 109.88, 81.29, 81.09, 65.67, 64.28, 61.01, 51.98, 51.55, 51.05, 47.27, 47.00, 45.60, 41.81, 39.04, 36.88, 36.66, 28.45, 26.79, 21.55.

HRMS: [M+H]⁺; C₅₇H₅₅N₄O₁₂⁺ calculated: 987.3811, found: 987.3789.

### Synthesis of Sequences 1001, 1010, 21, 11, 22, 2121, 2211

The sequences 1001, 1010, 21, 11, 22, 2121, 2211 were obtained using GP1 and GP2. Due to the complex nature of the products, NMR spectroscopy was not performed. Instead SEC and LCMS confirmed the successful synthesis of these molecules.

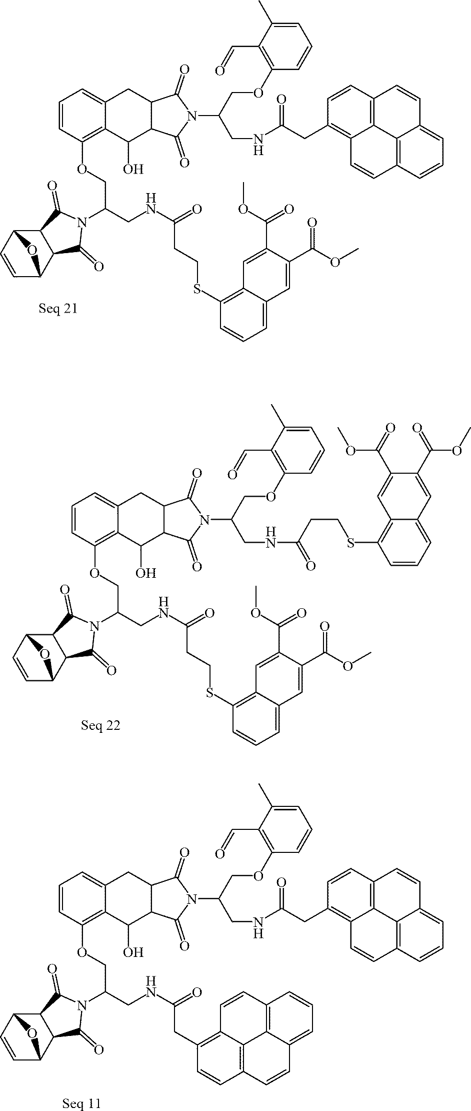

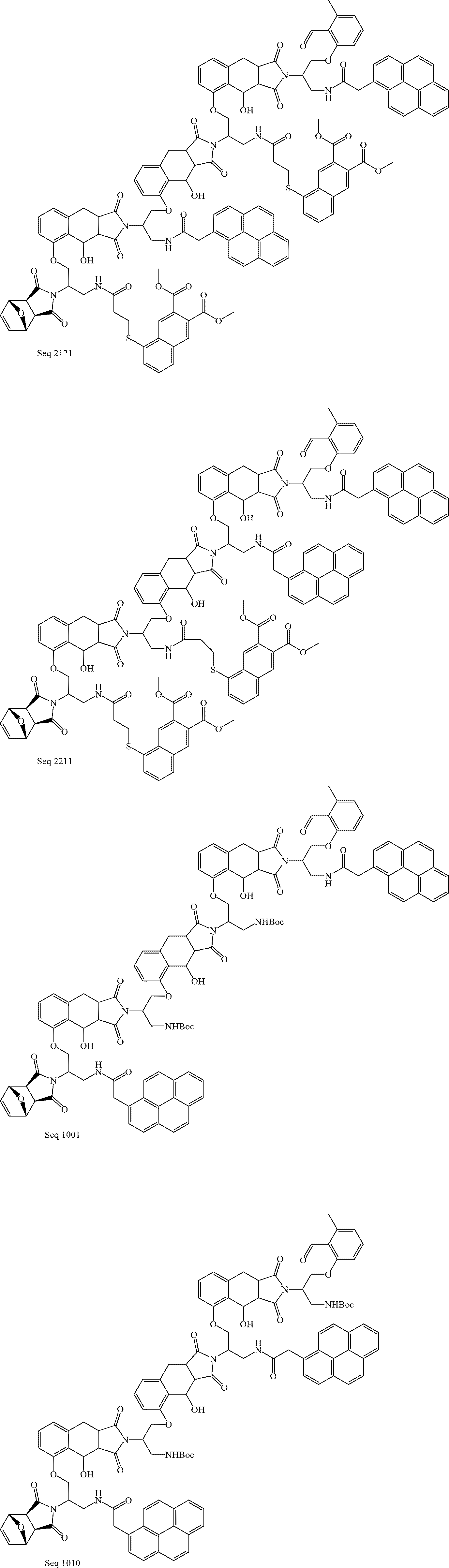

Sequene 21: HRMS: [M+H]⁺; C₆₉H₆₁N₄O₁₅S⁺ calculated: 1217.3849, found: 1217.3805.

Sequene 11: HRMS: [M+H]⁺; C₇₀H₅₇N₄O₁₁⁺ calculated: 1129.4018, found: 1129.3967.

Sequene 22: HRMS: [M+H]⁺; C₆₈H₆₅N₄O₁₉S₂⁺ calculated: 1305.3679, found: 1305.3629.

Sequene 1001: HRMS: [M+H]⁺; C₁₁₀H₁₀₅N₈O₂₃⁺ calculated: 1906.7321, found: 1906.7382.

Sequene 1010: HRMS: [M+H]⁺; C₁₁₀H₁₀₅N₈O₂₃⁺ calculated: 1906.7321, found: 1906.7447.

Sequene 2121: HRMS: [M+NH_{4]}⁺ ; C₁₃₄H₁₂₀N₉O₂₉S₂⁺ calculated: 2383.7661, found: 2383.7622.

Sequene 2211: HRMS: [M+H]⁺ ; C₁₃₄H₁₂₀N₉O₂₉S₂⁺ calculated: 2383.7661, found: 2383.7723.

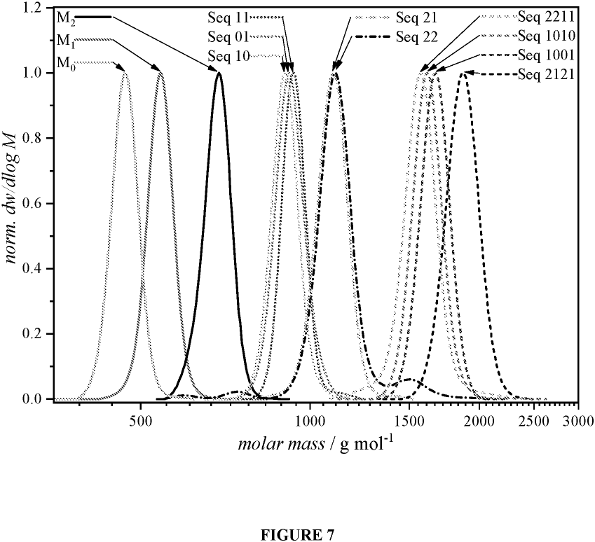

The respective SEC-traces are depicted in FIG. 7.

### General Procedure of Incorporating and Obtaining an Optical Readout From Fluorescent Sequence-Defined Macromolecules

1.) Blend a quantity of bulk material with the fluorescent macromolecule at low concentration (10⁻⁶ to 10⁻⁸ mol/cm⁻³);
2.) Excitation of the bulk material with the fluorescent macromolecule with a broad band light source (alternatively monochromatic light with a LED and filter) and measurement of the fluorescence with a RGB-chip;
3.) Conversion of the RGB-raw data to spectral data (RGB sensitivity curves of the used camera or calibration against reference material necessary);
4.) Deconvolution of the spectra;
5.) Selection of characteristic features in the deconvoluted spectra and matching with a database containing the assignment of spectra with a respective sequence or a respective pairing of fluorophores respectively;
6.) Assignment a single sequence. If sequence matching is satisfactory, a successful readout is achieved.

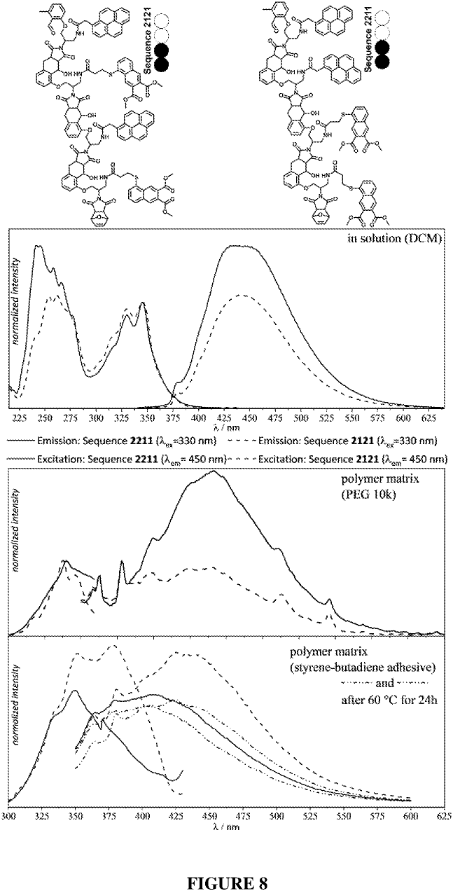

A representative example for characteristic fluorescence spectra of sequences 2121 and 2211 in solution and in a polymer matrix is depicted in FIG. 8. In that case, solid-state samples were prepared by mixing a solution of a given fluorescent macromolecule in dichloromethane with a styrene-butadiene adhesive, for a final fluorescent macromolecule concentration of 0.02 wt%. The mixture was applied to a glass slide and dried at room temperature for 24 h prior to fluorescence measurements. For temperature stability tests, these solid state samples were heated to 60 C for 24 h and their fluorescence spectra were reacquired.

It is to be understood that various other modifications and/or alterations may be made without departing from the spirit of the present invention as outlined herein.

1. A fluorescent macromolecule comprising:
a linear sequence-defined backbone; and
a plurality of fluorophores attached to the backbone in a pre-determined order to form a fluorophore sequence,
wherein the fluorophores in the fluorophore sequence are separated from one another by a distance permitting interaction between adjacent fluorophores such that the macromolecule emits fluorescence at a plurality of wavelengths when irradiated by light to form a fluorescence emission spectrum, and
wherein the fluorescence emission spectrum has a profile that is determined by the fluorophore sequence.

2. A fluorescent macromolecule according to claim 1, wherein the fluorophore sequence comprises at least one fluorophore pair providing excimer, exciplex or H-dimer fluorescence.

3. A fluorescent macromolecule according to claim 1, wherein the linear, sequence-defined backbone comprises a fluorophore backbone unit of formula (I): 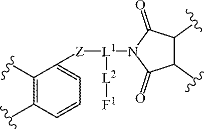
wherein: 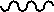
represents linkage to a cyclohexyl moiety coupling the backbone unit to an adjacent backbone unit;
Z is selected from O, N and S;
L¹ is a first linker group that may be absent or present and when present is selected from an optionally substituted linear or branched C₁ to C₄ saturated or unsaturated aliphatic group optionally comprising one or more heteroatoms selected from O, N and S;
L² is a second linker group selected from an optionally substituted saturated or unsaturated C₁ to C₁₆ aliphatic group, an optionally substituted aryl group, and an optionally substituted heteroaryl group, wherein said aliphatic, aryl or heteroaryl group optionally comprises at least one of a heteroatom selected from O, N and S, and a divalent functional group; and
F¹ is a fluorophore.

4. A fluorescent macromolecule according to claim 1, wherein the backbone comprises a fluorophore backbone unit of formula (II): 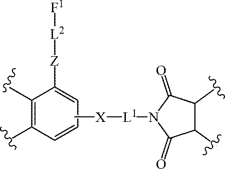
wherein: 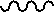
represents linkage to a cyclohexyl moiety coupling the backbone unit to an adjacent backbone unit;
Z is selected from O, N and S;
X may be absent or present, and when present is a heteroatom selected from O, N and S;
L¹ is a first linker group that may be absent or present, and when present is selected from an optionally substituted linear or branched C₁ to C₄ saturated or unsaturated aliphatic group optionally comprising one or more heteroatoms selected from O, N and S;
L² is a second linker group selected from an optionally substituted saturated or unsaturated C₁ to C₁₆ aliphatic group, an optionally substituted aryl group, and an optionally substituted heteroaryl group, wherein said aliphatic, aryl or heteroaryl group optionally comprises at least one of a heteroatom selected from O, N and S, and a divalent functional group; and
F¹ is a fluorophore.

5. A fluorescent macromolecule according to claim 1, wherein the backbone comprises a fluorophore backbone unit of formula (III): 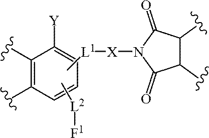
wherein: 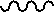
represents linkage to a cyclohexyl moiety coupling the backbone unit to an adjacent backbone unit;
Y is selected from OR², NR²R³, SR², S(O)R², and S(O₂)R²;
R² and R³ may each be independently selected from H, an optionally substituted saturated or unsaturated C₁-C₂₂ aliphatic group comprising one or more heteroatoms selected from O, N and S, an optionally substituted C₆ to C₁₂ cycloalkyl or fused polycycloalkyl, an optionally substituted aryl, and an optionally substituted heteroaryl;
X may be absent or present, and when present is a heteroatom selected from O, N and S;
L¹ is a first linker group that may be absent or present, and when present is selected from an optionally substituted linear or branched C₁ to C₄ saturated or unsaturated aliphatic group optionally comprising one or more heteroatoms selected from O, N and S;
L² is a second linker group selected from an optionally substituted saturated or unsaturated C₁ to C₁₆ aliphatic group, an optionally substituted aryl group, and an optionally substituted heteroaryl group, wherein said aliphatic, aryl or heteroaryl group optionally comprises at least one of a heteroatom selected from O, N and S, and a divalent functional group; or
L² is a heterocycloalkyl group fused with the phenyl ring and F¹; and
F¹ is a fluorophore.

6. A fluorescent macromolecule according to claim 1, wherein the linear backbone comprises a combination of two or more fluorophore backbone units selected from formula (I), (II) and (III).

7. A fluorescent macromolecule according to claim 1, wherein the backbone units are derived from a heterobifunctional monomer comprising a maleimido functional group and a benzaldehyde functional group, and wherein the maleimido and benzaldehyde functional groups react with one another under light irradiation to the form a cyclohexyl moiety linking the backbone units together.

8. A fluorescent macromolecule according to claim 3, wherein the cyclohexyl-linked backbone units have a structure of formula (V): 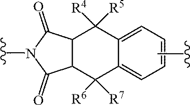
wherein:
R⁴ is OH,
R⁵ is selected from hydrogen, optionally substituted saturated or unsaturated C₁-C₂₂ alkyl, optionally substituted saturated or unsaturated C₁-C₂₂ heteroalkyl, optionally substituted aryl, optionally substituted heteroaryl, optionally substituted amino, and optionally substituted C₁-C₂₂ alkoxy,
R⁶ and R⁷ are each independently selected from hydrogen, optionally substituted saturated or unsaturated C₁-C₂₂ alkyl, optionally substituted saturated or unsaturated C₁-C₂₂ heteroalkyl, optionally substituted aryl, optionally substituted heteroaryl, optionally substituted amino, and optionally substituted C₁-C₂₂ alkoxy, or R⁶ and R⁷ together form a optionally substituted 4 to 8-membered cycloalkyl or heterocycloalkyl ring; or
one of R⁶ and R⁷ forms an optionally substituted 6 to 9-membered cycloalkyl or hetercycloalkyl ring fused with the phenyl ring.

9. A fluorescent macromolecule according to claim 1, wherein the fluorophore is selected from an optionally substituted bicyclic aryl, optionally substituted polycyclic aryl, and optionally substituted arylheterocyclyl, wherein the optional substituent is selected from halo, linear or branched C₁₋₂₂ alkyl, linear or branched C₂₋₂₀ alkenyl, linear or branched C₂₋₂₀ alkynyl, C₃₋₂₀ cycloalkyl, C₆₋₁₄ aryl, C₅₋₁₄ heteroaryl, N(R¹)₂, OR¹, SR¹, S(O)R¹, S(O₂R¹), C(O)R¹, C(O₂)R¹, C(O)NHR¹ and C(O)N(R¹)₂, where R¹ is selected from a hydrogen atom and a saturated or unsaturated C₁ to C₂₂ aliphatic group optionally comprising one or more heteroatoms selected from N, O and S, an aryl group, and a heteroaryl group with thio-ether, amino, alkoxy or alkyl groups with 1 to 22 carbon atoms, and wherein a substituent group is optionally fused with the fluorophore.

10. A fluorescent macromolecule according to claim 1, wherein the fluorophore is selected from one or more of the following optionally substituted structures: 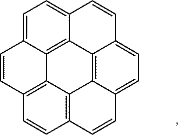 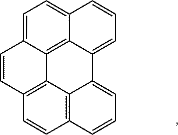 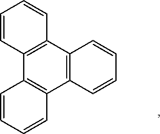 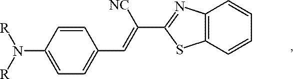 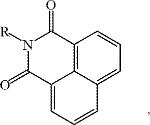 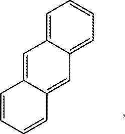 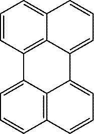 [SMILES: c1cc2cccc3c4cccc5cccc(c(c1)c23)c54] 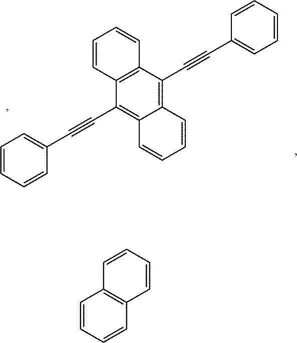 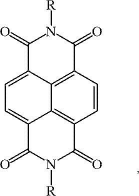 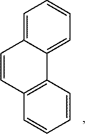 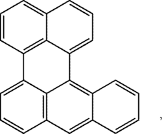 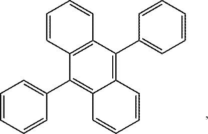 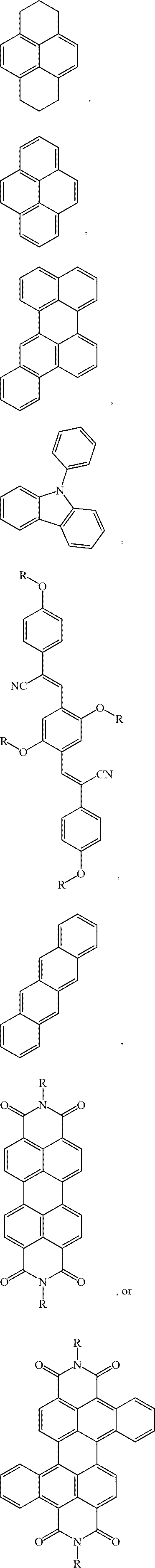
wherein the optional substituent is selected from halo, carboxy, hydroxyl, C₁₋₂₀-alkyl, C₂₋₂₀-alkenyl, C₂₋₂₀-alkynyl, C₃₋₂₀-cycloalkyl, C₁₋₂₀-alkoxy, -NR′R″ C₆₋₁₄-aryl, and C₅₋₁₄-heteroaryl, where R′ and R″ are simultaneously or independently H or C₁₋₂₂alkyl, and wherein R is selected from optionally substituted C₁₋₂₂ alkyl, optionally substituted C₂₋₂₀ alkenyl, optionally substituted C₂₋₂₀ alkynyl, optionally substituted C₃₋₂₀ cycloalkyl, optionally substituted C₆₋₁₄ aryl, and optionally substituted C₅₋₁₄ heteroaryl optionally.

11. A fluorescent macromolecule according to claim 1, wherein the fluorophore is an optionally substituted fluorophore of formula (XV): 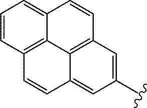
.

12. A fluorescent macromolecule according to claim 1, wherein the backbone comprises backbone units arranged in a predetermined sequence to encode information, the sequence of backbone units comprising at least one non-fluorophore backbone unit and a plurality of fluorophore backbone units, wherein the plurality of fluorophore backbone units optionally comprises a pair of fluorophore backbone units.

13. An article comprising the fluorescent macromolecule of claim 1.

14. A method for encoding and retrieving information comprising the steps of:
providing a fluorescent macromolecule according to claim 1, the macromolecule having predetermined sequence of fluorophores attached thereto to encode information;
irradiating the fluorescent macromolecule with light to obtain a fluorescence emission spectrum; and
analysing the fluorescence emission spectrum to determine the sequence of fluorophores and retrieve the encoded information.

15. A method for determining the authenticity of an article, the method comprising the steps of:
providing an article comprising a fluorescent macromolecule according to claim 1, the macromolecule having predetermined sequence of fluorophores attached thereto to encode information;
irradiating the article with light to obtain a fluorescence emission spectrum;
analysing the fluorescence emission spectrum to determine the sequence of fluorophores and retrieve the encoded information; and
comparing the retrieved information to an authentication code to authenticate the article.
